(19) United States
(12) Patent Application Publication
(10) Pub. No.: US 2026/0238596 A1
(43) Pub. Date: Aug. 13, 2026

(54) ADAPTING DISCARD MECHANISM TO XTENDED TRAFFIC

(71) Applicant: InterDigital Patent Holdings, Inc., Wilmington, DE (US)

(72) Inventors: Tejaswinee Lutchoomun, Montreal (CA); Jaya Rao, Montreal (CA); Oumer Teyeb, Montreal (CA)

(73) Assignee: InterDigital Patent Holdings, Inc., Wilmington, DE (US)

(21) Appl. No.: 19/471,846

(22) PCT Filed: Apr. 4, 2024
(86) PCT No.: PCT/US2024/022917

§ 371 Date: Oct. 2, 2025

Related U.S. Application Data
(60) Provisional application No. 63/456,958, filed on Apr. 4, 2023.

(51) Int. Cl. H04L 47/24; H04L 1/1607; H04L 47/32

(52) U.S. Cl. CPC H04L 47/24; H04L 1/1685; H04L 47/32

(57) ABSTRACT

A wireless transmit/receive unit (WTRU) may receive configuration information that indicates a protocol data unit (PDU) set priority value. The WTRU may determine that a PDU set is associated with a priority that is higher than the PDU set priority value. The WTRU may determine, based on the determination that the PDU set is associated with the priority that is higher than the PDU set priority value and a determination that a status report associated with the PDU set has not been received by the WTRU, that a polling indicator is to be sent. The WTRU may send the polling indicator. The polling indicator may indicate a request for a transmission of the status report associated with the PDU set.

### CROSS-REFERENCE TO RELATED APPLICATIONS

This application claims the benefit of U.S. Provisional Application No. 63/456,958, filed Apr. 4, 2023, the content of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Described herein are systems, methods, and instrumentalities associated with a wireless transmit/receive unit (WTRU) configured to send a polling indicator.

In examples, a WTRU may receive configuration information that indicates a protocol data unit (PDU) set priority value. The WTRU may determine that a PDU set is associated with a priority that is higher than the PDU set priority value. The WTRU may determine, based on the determination that the PDU set is associated with the priority that is higher than the PDU set priority value and a determination that a status report associated with the PDU set has not been received by the WTRU, that a polling indicator is to be sent. The WTRU may send the polling indicator. The polling indicator may indicate a request for a transmission of the status report associated with the PDU set. In some examples, the WTRU may receive an indication of a time period, determine that the status report has not been received by the WTRU within the time period, and send the polling indicator. For example, the WTRU may send the polling indicator to a network in a packet data convergence protocol (PDCP) packet. The WTRU may send the polling indicator to a network in a radio link control (RLC) packet. The status report associated with the PDU set is used to indicate a reception of the PDU set. The PDU set priority indicates an importance level of the PDU set for an Xtended reality (XR) application.

In examples, the WTRU may determine a PDU set delay budget (PSDB) threshold and determine that a PSDB associated with the PDU set is less than the PSDB threshold. The WTRU may determine to send the polling indicator further based on the determination that the PSDB associated with the PDU set is less than the PSDB threshold.

In examples, the WTRU may determine a PDU reception rate associated with the PDU set. The PDU reception rate may indicate a number or a percentage of PDUs of the PDU set that have been received. The WTRU may determine that the PDU reception rate associated with the PDU set is equal to or less than a PDU reception threshold. The WTRU may determine to send the polling indicator further based on the determination that PDU reception rate associated with the PDU set is equal to or less than the PDU reception threshold.

In examples, the WTRU may receive, after the polling indicator is sent, the status report associated with the PDU set. The status report may indicate the reception of the PDU set. The WTRU may determine that the PDU set has been received based on the status report and discard the PDU set based on the determination that the PDU set has been received.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment.

FIG. 2 is an example showing a determination to send a polling indicator and the transmission of the polling indicator.

### DETAILED DESCRIPTION

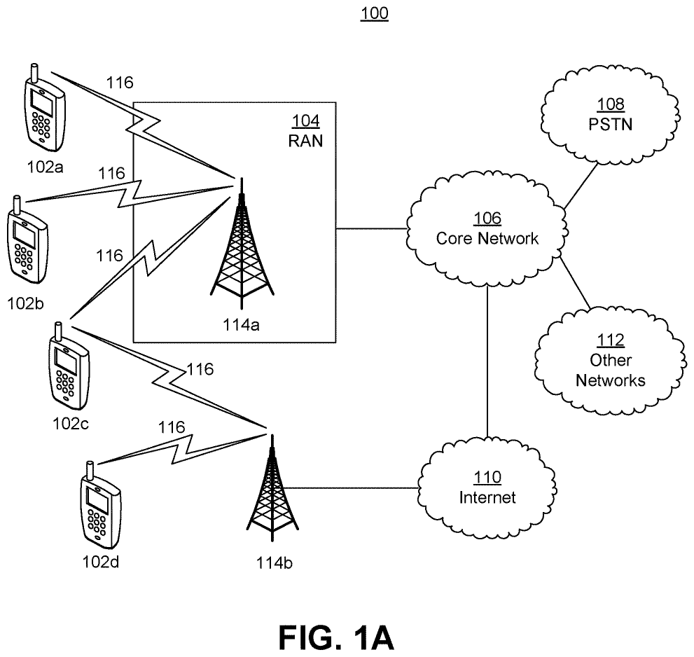

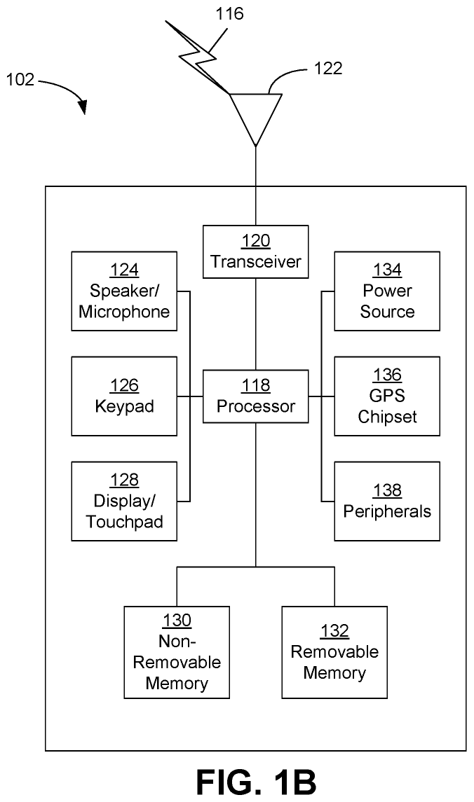

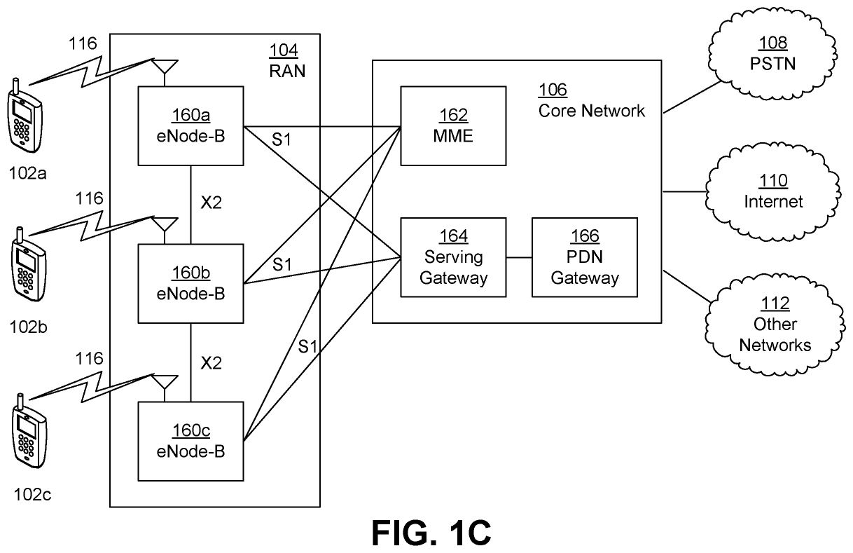

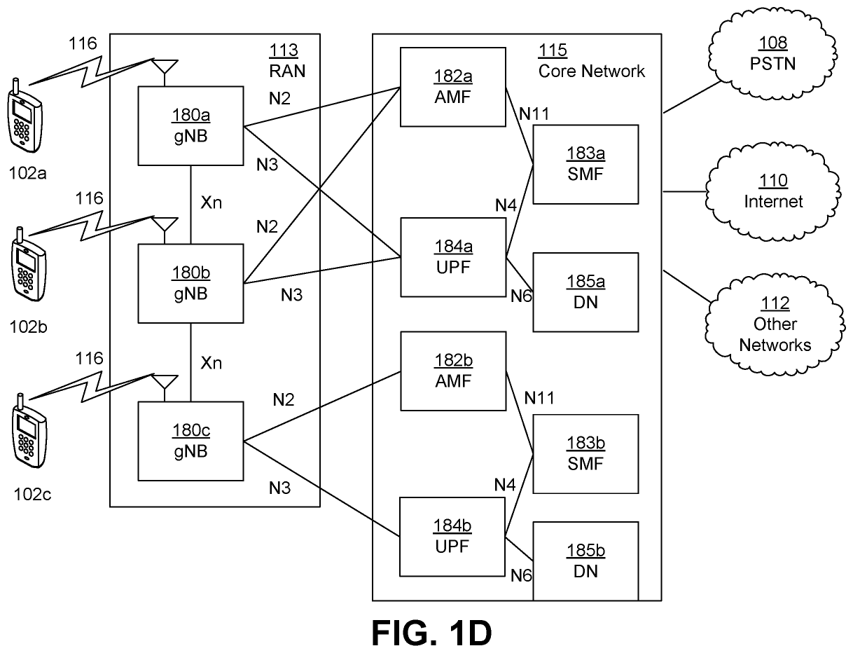

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may Inother CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode.

In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are systems, methods, and instrumentalities associated with a wireless transmit/receive unit (WTRU) configured to send a polling indicator.

In examples, a WTRU may receive configuration information that indicates a protocol data unit (PDU) set priority value. The WTRU may determine that a PDU set is associated with a priority that is higher than the PDU set priority value. The WTRU may determine, based on the determination that the PDU set is associated with the priority that is higher than the PDU set priority value and a determination that a status report associated with the PDU set has not been received by the WTRU, that a polling indicator is to be sent. The WTRU may send the polling indicator. The polling indicator may indicate a request for a transmission of the status report associated with the PDU set. In some examples, the WTRU may receive an indication of a time period, determine that the status report has not been received by the WTRU within the time period, and send the polling indicator. For example, the WTRU may send the polling indicator to a network in a packet data convergence protocol (PDCP) packet. The WTRU may send the polling indicator to a network in a radio link control (RLC) packet. The status report associated with the PDU set is used to indicate a reception of the PDU set. The PDU set priority indicates an importance level of the PDU set for an Xtended reality (XR) application.

In examples, the WTRU may determine a PDU set delay budget (PSDB) threshold and determine that a PSDB associated with the PDU set is less than the PSDB threshold. The WTRU may determine to send the polling indicator further based on the determination that the PSDB associated with the PDU set is less than the PSDB threshold.

In examples, the WTRU may determine a PDU reception rate associated with the PDU set. The PDU reception rate may indicate a number or a percentage of PDUs of the PDU set that have been received. The WTRU may determine that the PDU reception rate associated with the PDU set is equal to or less than a PDU reception threshold. The WTRU may determine to send the polling indicator further based on the determination that PDU reception rate associated with the PDU set is equal to or less than the PDU reception threshold.

In examples, the WTRU may receive, after the polling indicator is sent, the status report associated with the PDU set. The status report may indicate the reception of the PDU set. The WTRU may determine that the PDU set has been received based on the status report and discard the PDU set based on the determination that the PDU set has been received.

Described herein are systems, methods, and instrumentalities associated with a wireless transmit/receive unit (WTRU) configured to send a polling indicator at a packet data convergence protocol (PDCP) level or send a polling indicator at a radio link control (RLC) level based on at least an importance associated with a protocol data unit (PDU) set.

For example, a WTRU may receive configuration information indicating a PDU set importance threshold. The WTRU may receive a PDU set and determine a PDU set importance associated with the PDU set. The WTRU may determine to send a polling indicator (e.g., to a network) based on the PDU set importance threshold and the PDU set importance associated with the PDU set. The WTRU may send the polling indicator, for example, as a transmission PDCP entity.

The WTRU may determine that a status report is not received. The status report, if received, may indicate a successful delivery of the PDUs of the PDU set. The polling indicator may be sent to the network based on the determination that the status report is not received (e.g., within a time window if the configuration information indicates the time window). The WTRU may determine a size of the PDU set and send an indication of the size of the PDU set to the network, for example, if the WTRU is a transmission RLC entity. The configuration information may indicate a PDU set delay budget (PSDB) threshold, and the polling indicator may be determined to be sent based on the PSDB threshold.

If the WTRU receives a status report indicating a successful delivery of a PDU set, this PDU set may be discarded, for example, at a PDCP level or at an RLC level.

In one or more examples herein, a discard mechanism (at PDCP and/or RLC) may be implemented. Polling may be introduced at PDCP. Polling (e.g., enhanced polling) may be used at RLC.

PDUs of PDU sets (at PDCP and RLC) may be held before being sent (e.g., to the lower layers such as MAC), for example, to facilitate discarding (e.g., to ensure that discard happens).

For important PDU set(s), features or elements in one or more examples herein may be used to facilitate (e.g., ensure) that discard happens (e.g., only happens) after a WTRU receives a status report confirming the successful delivery of the important PDU set(s). Polling (e.g., a polling mechanism) may be introduced at PDCP. PDU set importance may be considered for RLC polling (e.g., as enhancements of legacy RLC polling).

Features or elements in one or more examples herein may be used to facilitate (e.g., ensure) that discard can actually happen for PDU set(s) where a loss/delay of one PDU within the PDU set renders the remaining PDUs of the PDU set useless. Holding mechanism(s) may be introduced at PDCP. Holding mechanism(s) may be introduced at RLC. Discarding may happen at a receiving side PDCP.

Xtended reality (XR) may include augmented reality (AR), virtual reality (VR), mixed reality (MR), and the areas interpolated among them. An XR application provider may use system functionalities (e.g., the system functionalities as described in FIGS. 1A-1D) for XR services. A WTRU may include an XR aware application to use XR client and network functions using network interfaces and application programming interface (APIs).

In XR traffic, there may be dependencies in one or more of the following ways: between PDUs (e.g., within PDU sets or data bursts); between PDU sets; between data bursts; across multiple flows. PDU set(s) may be used for the handling and delivery of a group of PDUs belonging to a PDU set. In examples, there may be multiple (e.g., two) types of PDU sets include a first type of PDU sets (e.g., Type I) and a second type of PDU sets (Type II). The first type of PDU sets may not (e.g., cannot) tolerate any loss/delay for any PDU of the PDU set (e.g., when one of the PDUs is lost or delayed, the rest of the PDUs of the PDU set may be dropped). The second type of PDU sets can tolerate some loss/delay (e.g., an XR application can reconstruct a PDU set with a delay/loss of some PDUs of the PDU set). Table 1 provides an example of PDU set integrated indication (PSII or PSIHI).

TABLE 1
The following PDU set QoS parameters are defined to support PDU set
handling:
Whether all PDUs are needed for the usage of PDU set by application
layer (PDU set Integrated Indication).

The first type of PDU sets (e.g., type I PDU sets) may be marked with a PSIHI indicator. A PDU set importance may be introduced for XR traffic. A PDU set importance may be applicable to DL and uplink (UL) traffic. In addition to QoS parameters (e.g., PDU set delay budget (PSDB), PDU set error rate (PSER), a PDU set importance may provide an additional granularity into how packets can be treated (e.g., how packets can be treated at the AS layers). A PDU set importance may be relative from one PDU set to another. A PDU set importance may be marked (e.g., marked at application to be used at NG-RAN).

In examples, the PDU set importance may be an indication (e.g., a flag/indicator) indicating that a PDU set is important or not. For example, an absence of the flag/indicator indicates that the PDU set is not important. In some examples, a PDU set importance may be more granular. For example, there may be different levels corresponding to the different PDU set importance values (e.g., different scores corresponding to the different PDU set importance values). A higher importance value may indicate a higher importance. Importance values may be marked by the application/higher layers in a WTRU. In one or more examples herein, the lower layers (e.g., AS layers) in the WTRU may be able to read the importance values. The importance values may impact one or more of the functions at the WTRU (e.g., an importance value indicates an extent of such impact). For example, for an important PDU set, the discard at the PDCP layer may be delayed. For an important PDU set, the discard of the PDU set may occur (e.g., only occur) after a status report confirming the successful delivery of the PDU set at the receiving side has been received.

A PDU set may include a group of PDUs (e.g., corresponding to one video frame). In some applications, the PDUs (e.g., all PDUs) of the PDU set are needed for the decoding of the PDU set. If one or more of the PDUs of the PDU set are determined (e.g., known) to be lost/delayed, the remaining PDUs of the PDU set may be rendered unusable for the applications (e.g., useless to the application(s)). Discarding of PDUs may be frequent for XR services (e.g., more frequent than for non-XR services. Some discarding mechanisms may be designed to consider discard as an error case (e.g., legacy discarding mechanisms may be designed to consider discard as an error case and insufficient for handling XR traffic). This may not be the case for XR traffic where discard is frequent. Some discarding mechanisms (e.g., the ones designed to consider discard as an error case) may not consider characteristics of XR traffic.

Some discard mechanisms (e.g., legacy discard mechanisms) may include the following. PDCP discard may happen when discard timer expires for a PDCP Service Data Unit (SDU), or when the successful delivery of the PDCP SDU is confirmed by a PDCP status report, for example, as shown in Table 2. Table 2 shows an example of PDCP discard for the example discard mechanisms (e.g., legacy discard mechanisms). RLC discard may happen if a PDU has not been submitted to the lower layers (MAC). Table 3 shows an example of RLC discard for the example discard mechanisms (e.g., legacy discard mechanisms).

TABLE 2
When the discardTimer expires for a PDCP SDU, or the successful delivery of a PDCP SDU is
confirmed by PDCP status report, the transmitting PDCP entity shall discard the PDCP SDU along with
the corresponding PDCP Data PDU. If the corresponding PDCP Data PDU has already been submitted
to lower layers, the discard is indicated to lower layers.
NOTE: Discarding a PDCP SDU already associated with a PDCP SN causes a SN gap in the
transmitted PDCP Data PDUs, which increases PDCP reordering delay in the receiving
PDCP entity. It is up to WTRU implementation how to minimize SN gap after SDU discard.

TABLE 3
When indicated from upper layer (e.g., PDCP) to discard a particular RLC
SDU, the transmitting side of an AM RLC entity or the transmitting UM
RLC entity shall discard the indicated RLC SDU, if neither the RLC SDU
nor a segment thereof has been submitted to the lower layers. The
transmitting side of an AM RLC entity shall not introduce an RLC SN gap
when discarding an RLC SDU.

XR traffic may have low latency requirements (e.g., latency requirements that are lower than non-XR traffic). Discard may occur (e.g., often occur) for XR traffic (e.g., discard may occur more frequently for XR traffic than for non-XR traffic). Discard procedure(s) that do not increase/introduce additional delays may be used. For important PDU set(s), features or elements may be used to facilitate (e.g., ensure) that discard happens (e.g., only happens) after a WTRU receives a status report confirming the successful delivery of the important PDU set(s).

In one or more examples herein, polling may be used to facilitate (e.g., ensure) that, for an (e.g., every) important PDU set, a transmitting entity sends a polling bit/indication to a receiving entity. The importance of a PDU set may be indicated by a priority associated with the PDU set. In response to the polling bit/indication, the receiving entity may send a status report associated with the PDU set to the transmitting entity. The status report associated with the PDU set, if received by the transmitting entity, may indicate the delivery status of the PDU set (e.g., confirming the delivery status of the PDU set). The delivery status of the PDU set may be that the PDU set has been received. The transmitting entity may not discard the PDU set until the status report (e.g., the status report confirming the successful delivery of the PDU set) is received. For example, the transmitting entity may only discard a PDU set upon the reception of a status report confirming a successful delivery of the PDU set.

Sending a polling bit/indication for the (e.g., every) important PDU set may facilitate (e.g., ensure) that an important PDU set is not discarded unless/until a status report confirming the successful delivery of the PDU set at the receiving (Rx) side is received, and facilitate that the important PDU set can be discarded without introducing additional delays (e.g., the important PDU set can be discarded as soon as the status report is received).

In one or more examples as described herein, polling may be introduced at PDCP (e.g., as opposed to some examples where a polling mechanism is not used at PDCP). For example, a polling indicator may be sent in a PDCP packet or a PDCP header. In one or more examples as described herein, polling may used at RLC based on a PDU set importance and/or a PDU set association or dependency (e.g., as opposed to examples where a PDU set importance or PDU dependencies are not considered for polling at RLC or examples where polling at RLC is defined without the PDU set importance or the PDU dependencies (e.g., defined blindly such that a polling indicator is added for every n PDUs or for every n bytes)). For example, a polling indicator may be sent in an RLC packet or an RLC header.

Some PDU sets may be associated with (e.g., marked by) a PDU set integrated handling indication (PSIHI). The PSIHI indicator may be used to indicate that for the type of PDU set associated with the PSIHI, a loss/delay of one PDU within the PDU set renders the remaining PDUs of the PDU set unusable for some purposes (e.g., the remaining PDUs may be rendered useless). Discard may be required for the remaining PDUs that are in the same PDU set with the PDU that was lost/delayed (e.g., discard may need to happen often for XR traffic). In some examples, once PDUs are submitted to the lower layers (e.g., MAC), discard may not happen. In one or more examples herein, features or elements may be used to facilitate (e.g., ensure) the discarding of PDU set(s) if a loss/delay of one PDU within the PDU set renders the remaining PDUs of the PDU set useless.

In one or more example herein, for PDU set(s) associated with PSIHI indicator(s), features or elements may be used to facilitate (e.g., ensure) that PDUs in the PDU set(s) associated with PSIHI indicator(s) are collectively discarded (e.g., since, once PDUs are submitted to the MAC, discarding may not be possible). In one or more example herein, features or elements may be used to facilitate (e.g., ensure) that, when discarding is triggered, new data (e.g., PDUs of the PDU set) is not submitted to lower layers and that data already submitted to the lower layers is discarded. These features or elements in one or more examples herein may prevent unnecessary (re)transmissions. In one or more examples as described herein, a holding scheme may be used to ‘hold on’ to the PDUs of a PDU set (e.g., one or more of the remaining PDUs of a PDU set, for example, a PDU set associated with PSIHI indicator(s)) at the PDCP layer until more PDUs of the PDU set are received at the PDCP (e.g., at the PDCP layer). In one or more example as described herein, RLC may ‘hold on’ to the PDUs of a PDU set associated with a PSIHI indicator until RLC receives an indication (e.g., from the lower layers such as MAC) indicating that there are enough grants/resources to accommodate the entire PDU set (e.g., to ensure discard happens when needed). Some examples herein may concern discarding at the transmitting side (e.g., transmitting PDCP or RLC). In example 2(C), if some PDUs of a PDU set associated with a PSIHI indicator have been transmitted despite a loss/delay of a PDU of the PDU set, the receiving entity may perform discarding.

In one or more examples as described herein, polling may be introduced at PDCP (e.g., a polling indicator may be sent via a PDCP layer). A WTRU may be configured to send a polling bit/flag associated with a PDU set that has certain characteristics (e.g., a certain PDU set importance), to trigger status report(s) regarding the successful reception of the PDU set (e.g., as opposed to some examples where a status polling at PDCP level does not occur). For example, a WTRU (e.g., a transmitting (Tx) PDCP) may receive, from a network, configuration information indicating one or more of: a configuration associated with polling; PDU set importance threshold(s) (e.g., P1); or time window threshold(s) (e.g., T1) that may be used to trigger polling. In examples, T1 may be a timer created as a standalone timer or as a function of PDU set delay budget (e.g., PSDB). The WTRU may receive data associated with a PDU set, for example, from higher layers (e.g., application layer(s)). The WTRU may receive or derive the importance of the PDU set (e.g., based on a priority of the PDU set). The WTRU may send a polling indicator to the network based on the importance of the PDU set and/or other information. For example, at T1, if the importance of the PDU set is greater than a PDU set importance threshold P1, and the WTRU has not received a status report confirming the successful delivery of PDUs of the PDU set, the WTRU may send a polling indicator to the network. In examples, one status report may be sent for the PDU set. In some examples, multiple status reports may be sent for the PDUs of the PDU set. If the WTRU receives status report(s) from the network confirming the successful delivery of the PDU set/PDUs of the PDU set, the WTRU (e.g., a Tx PDCP) may discard the PDU set.

In example 1 (B), polling may be used at RLC (e.g., a polling indicator may be sent via an RLC layer). A WTRU may be configured to introduce RLC polling that is PDU set specific (e.g., based on information associated with the PDU set or PDU dependencies, for example, dependencies between PDUs of a PDU set or between different PDU sets), to trigger status report(s) regarding the successful reception of a PDU set (e.g., as opposed to some examples where RLC polling is only based on the number of PDUs and/or the number of bytes sent, with no information about PDU sets or PDU dependencies). A WTRU (e.g., a Tx RLC) may receive configuration information from a network indicating a configuration associated with polling. For example, the configuration information may indicate one or more of: polling on a PDU set basis; PDU set importance threshold(s) (e.g., T1); or PSDB threshold(s) (D1) which may be used to trigger polling. The WTRU may receive data in a PDU set, for example, from higher layers (e.g., application layer(s)). The WTRU may receive or derive the size of the PDU set (e.g., # of PDUs in PDU set, start/end of PDU set, etc.). The WTRU may receive or derive the importance of the PDU set (e.g., based on a priority associated with the PDU set). The WTRU may send to the network an indication that indicates the size of the PDU set. The WTRU may send a polling indicator (e.g., a polling bit/flag) to the network based on the importance of the PDU set and/or other information. For example, the WTRU (e.g., transmitting RLC) may send a polling bit/flag to the network if the importance of the PDU set is greater than the PDU set importance threshold T1, and the PSDB is less than the PSDB threshold D1. If the WTRU receives a status report confirming the successful delivery of the PDU set, the WTRU (e.g., a Tx RLC) may discard the PDU set.

One or more examples as described herein may facilitate (e.g., ensure) that discard happens at PDCP (e.g., at a PDCP layer). PDCP (e.g., a PDCP entity and/or a WTRU through a PDCP layer) may be configured to delay sending (e.g., to lower layers) one or more PDUs of a PDU set, for example, for a given time or until a certain number or percentage of the PDUs of the PDU set is received and/or delay sending an indication about a buffer status (e.g., the transmit buffer status) regarding the PDU set (e.g., as opposed to some examples where whether PDCP performs holding/pre-processing is not specified). For example, a WTRU (e.g., a Tx PDCP) may receive data in a PDU set, for example, from higher layers (e.g., application layer(s)). The WTRU may receive configuration information indicating a configuration associated with a holding mechanism from a network. For example, the configuration information may indicate (e.g., for the holding mechanism) a threshold T1 corresponding to the percentage of PDUs in PDU set to be received before the WTRU can send the PDU set (e.g., the percentage of the PDUs that must be received at PDCP before the WTRU can send the PDU set to lower layers). The WTRU may detect the presence/absence of a PSIHI indicator associated with the PDU set (e.g., in the header of the PDU set). The WTRU may receive or derive information about the size of the PDU set S1 (e.g., the start/end indication(s), the number of PDUs in the PDU set, size in bits/bytes, etc.). The WTRU (e.g., a Tx PDCP) may determine the percentage (X1) of PDUs of the PDU set that have been received at that time. If the WTRU detects the presence of the PSIHI indicator associated with the PDU set, and the percentage of PDUs (X1) of the PDU set that have been received at that time is less than or equal to the threshold T1, the WTRU (e.g., a Tx PDCP) may hold the PDUs until more PDUs of the PDU set are received (e.g., so that the percentage of the PDUs of the PDU set that have been received is greater than the threshold T1). The WTRU (e.g., a Tx PDCP) may generate a control PDU (e.g., a PDU that includes control information) to include information on a holding scheme, for example, on one or more of: the number of PDUs of the PDU set being held; a time duration of holding; the number of remaining PDUs of the PDU set; or the remaining number of PDUs of the PDU set before the WTRU can release the holding (e.g., the holding mechanism). The WTRU (e.g., a Tx PDCP) may send the control PDU to the network (e.g., an Rx PDCP at a gNodeB (gNB)).

One or more examples as described herein may facilitate the discarding at RLC (e.g., ensure the discarding happens at RLC). RLC (e.g., an RLC entity and/or a WTRU through an RLC layer) may be configured to send a PDU set associated with a PSIHI indicator when RLC receives an indication (e.g., only send a PDU set associated with a PSIHI indicator to the lower layers when RLC receives, from the lower layers, an indication) of availability of sufficient grants (e.g., as opposed to some examples where a status PDU can only be generated by the receiving side of an RLC entity with information on PDUs received successfully and PDUs that detected to be lost by the receiving side, as described in the example shown in Table 4). For example, a WTRU (e.g., a Tx RLC) may receive data associated with a PDU set, for example, from higher layers (e.g., application layer(s)). The WTRU (e.g., a Tx RLC) may detect the presence/absence of a PSIHI indicator associated with the PDU set. The WTRU may receive or derive information about the size S1 of the PDU set (e.g., start/end indication, the number of PDUs in the PDU set, size in bits/bytes, etc.). The WTRU may receive an indication (e.g., from lower layers such as MAC) on the availability of one or more grants and their respective size(s) (e.g., the size of more than one grant for configured grant(s) (CG(s)), the size of dynamic grant(s) (DG(s)), the size of (CG(s)+DG(s)) grant). If the sum (of the available grants) is equal to or greater than the size of the PDU set S1, the WTRU (e.g., a Tx RLC) may transmit data (e.g., to lower layers such as MAC). If the sum (of the available grants) is less than S1, and the WTRU detects the PSIHI indicator associated with the PDU set (e.g., the PSIHI indicator in the PDU set), the WTRU may retain data in a WTRU buffer (e.g., an RLC buffer). If the WTRU retains data in a WTRU buffer (e.g., a new WTRU buffer such as a new RLC buffer that is different from a legacy WTRU buffer; the new WTRU buffer may be a buffer additional to the legacy RLC buffer used to holder data such as PDUs of a PDU set), the WTRU has not received enough resources from one or more grants, and the PSDB is within a preconfigured window of expiring, the WTRU may trigger a transmission of a scheduling request (SR)/buffer status report (BSR). If the WTRU retains data in a WTRU buffer (e.g., a legacy WTRU buffer such as a legacy RLC buffer), the WTRU has not received enough resources from one or more grants, and the WTRU has received new data in the meantime, the WTRU may transmit data (e.g., to lower layers) if the WTRU buffer (e.g., the RLC buffer) is filled. In some examples, if the WTRU retains data in a WTRU buffer (e.g., a legacy WTRU buffer such as a legacy RLC buffer), and the WTRU has not received enough resources from one or more grants, and the WTRU has received new data in the meantime, the WTRU may determine action(s) based on the priority of the new data (e.g., the priority of the new data with regards to the priority of the PSIHI data). For example, if the priority of the new data is greater than the priority of the PDU set associated with the PSIHI indicator, the WTRU may transmit the new data (e.g., to the lower layers such as MAC). If the priority of the new data is equal to or less than the priority of the PDU set associated with the PSIHI indicator, the WTRU may transmit the PDU set associated with the PSIHI indicator (e.g., to the first available grant, irrespective of grant size). The WTRU (e.g., a Tx RLC) may generate a status PDU to inform the network (e.g., a Rx RLC) of the holding scheme at the WTRU, for example, including information on the amount of additional grant(s) needed to release the holding mechanism. In some examples, the WTRU (e.g., a Tx RLC) may send an indication (e.g., to the lower layers such as MAC) and the WTRU (e.g., MAC) may send an indication (e.g., a MAC control element (CE)) to the network to inform the network of the holding scheme at the WTRU, for example, including information on the amount of additional grant(s) needed to release the holding. In one or more examples as described herein, the transmitting side may perform status reporting, and the status report may be configured on a PDU set basis and/or may include information on how much additional grant is needed to release the holding (e.g., as opposed to some examples where a status PDU can only be generated by the receiving side of the RLC entity, which contains information about PDUs that are received successfully and PDUs that are detected to be lost by the receiving side).

TABLE 4
STATUS PDU is used by the receiving side of an AM RLC entity to
inform the peer AM RLC entity about RLC data PDUs that are received
successfully, and RLC data PDUs that are detected to be lost by the
receiving side of an AM RLC entity.

One or more examples as described herein may facilitate the discarding at Rx side PDCP (e.g., ensure that discard happens at Rx side PDCP on the downlink). Receiving PDCP may be configured to drop PDUs of a PDU set associated with a PSIHI indicator if some PDUs of the PDU set are lost/delayed (e.g., as opposed to some examples where receiving PDCP forwards all PDUs to an application layer). A WTRU (e.g., an Rx PDCP) may receive data associated with a PDU set (e.g., from the lower layers). A WTRU may receive an indication (e.g., from higher layers (e.g., application layer(s))) about data in a QoS flow that is to be treated as PSIHI data (e.g., the data that must be treated as PSIHI data, for example, based on encoding scheme(s) at application in the WTRU). For example, some data may not be marked as PSIHI type data by the network. The WTRU may receive the data in the DL. The data (e.g., the data not initially marked as PSIHI) is to be treated as PSIHI data, for example, based on the encoding scheme at the WTRU. The WTRU (e.g., an Rx PDCP) may detect, e.g., based on SN(s) of PDUs in a PDU set, the loss/delay of some PDUs of the PDU set (e.g., the PDU set now marked as PSIHI). The WTRU may send an indication to the network about the change in the status of the PDU set. In examples, if a PSDB is reached, the WTRU may discard other PDUs of the PDU set.

In one or more examples herein, the network may include any of a base station (e.g., gNB, transmission/reception point (TRP), RAN node, access node), core network function (e.g., AMF, SMF, PCF, NEF) and application function (e.g., edge server function, remote server function), for example.

In one or more examples herein, flows may correspond to any of: QoS flows or data flows (e.g., flow of data consisting of one or more PDUs, PDU sets or data bursts, which may be associated with one or more QoS requirements, e.g., latency, data rate, reliability, RTT latency). Different flows, possibly originating from a common application/experience source and/or intended to a common destination device/WTRU or group of associated devices/WTRU may be referred to associated flows or correlated flows.

In one or more examples herein, a data unit may refer to any of: one or more frames (e.g., media/video/audio frame or slice/segment), PDUs, PDU sets, data bursts, group of frames/PDUs/PDU-sets/data bursts.

In one or more examples herein, QoE may correspond to any of: application and/or higher layer metrics and measurements, which may be directly or indirectly detectable/visible at the WTRU and/or application function. Such QoE metrics and measurements may or may not be directly visible/detectable at the base station, for example. Such QoE metrics and measurements may be determined/performed as a function of QoS metrics/parameters (e.g., latency, data rate, reliability, RTT/MTP latency)

In one or more examples herein, forwarding configuration may correspond to any of the following: radio bearers (e.g., data radio bearers (DRBs) and/or signaling radio bearers (SRBs), logical channels (LCHs), logical channel groups (LCGs), configuration parameters in the individual layers within the AS protocol stack (e.g., SDAP, PDCP, RLC, MAC, physical layer (PHY), other new protocol layers), parameters associated with logical channel prioritization (LCP) (e.g., priority, prioritized bit rate (PBR), BSD), bandwidth parts (BWPs), carriers, radio links/interfaces (Uu links, SLs), and radio resources (e.g., set of one or more frequency/time/spatial resources such as symbols, slots, subcarriers, resource elements or beams). Radio resources may be associated with configurated grants (CG), dynamic grants (DG) and/or any other resource grants or grant free resources.

In one or more examples herein, mapping configuration may correspond to any of the following: parameters and/or configurations associated with mapping from one or more of data units, PDUs, SDUs, PDU sets, data bursts, application data (e.g., ADU) flows, QoS flows (e.g., associated or non-associated), which may originate from any of application layer, higher layers, and network to one or more of radio bearers (e.g., DRBs, SRBs), layers, sublayers or entities (e.g., SDAP, new layer, PDCP, RLC, MAC, PHY), LCHs, carriers or component carriers (e.g., CCs in CA configurations), BWPs, and radio links/interfaces (e.g., Uu link or sidelinks), which may be used for delivering the data/PDUs in UL direction or DL direction, for example.

In one or more examples herein, data unit, may correspond to any of the following: one or more frames (e.g., media/video/audio frame or slice/segment), PDUs, PDU sets, data bursts, group of frames/PDUs/PDU-sets/data bursts.

In one or more examples herein, XR/application-aware data transmissions/receptions or XR/application-aware QoS handling, may correspond to any of the following: attributes associated with PDU set, ADU or data burst; application/high layer importance/priority; QoS/data flow.

XR/application-aware data transmissions/receptions or XR/application-aware QoS handling may include attributes associated with PDU set, ADU or data burst. A PDU set (e.g., media unit, video frame) may comprise of one or more PDUs. A PDU set may be associated with PDU set-level QoS requirements (e.g., data rate, latency, error rate, reliability), which may be applicable for one or more or all PDUs associated with the PDU set. The different PDUs in a PDU set may be associated with individual PDU-level QoS requirements. A data burst may refer to the data produced by the application in a short period of time, comprising PDUs from one or more PDU sets. Such attributes, associations and inter-dependencies (e.g., intra-PDU set and/or inter-PDU set), including the start/end indication of a PDU set/data burst (e.g., via sequence number, start/end indication), start/end time, duration, payload sizes, periodicity, importance/priority and QoS (e.g., PSDB) may be visible to the AS-layers (e.g., with associated IDs) and/or handled at the AS layers with the awareness of the association during data transmission in UL and reception in DL.

XR/application-aware data transmissions/receptions or XR/application-aware QoS handling may include application/high layer importance/priority. The different PDUs in a PDU set or all PDUs in a PDU set may be associated with different application/high layer importance/priority values. Such importance value may correspond to spatial importance (e.g., spatial position of the video frame whose data is carried by the PDU/PDU set, where PDUs/PDU set carrying FoV spatial positions may be associated with higher spatial importance than non-FoV spatial positions) or temporal importance (e.g., time sequence of the video frame who data is carried by the PDU/PDU set, where PDUs/PDU sets carrying base video frames such as I-frame may be associated with higher temporal importance than differential video frames such as P-frame/B-frame). Such importance values may be visible to the AS layers (e.g., with associated IDs/markers/indications), possibly enabled by application awareness, during data transmission and reception.

XR/application-aware data transmissions/receptions or XR/application-aware QoS handling may include QoS/data flow. The PDUs/PDU sets of an application may be encoded and delivered by the application to WTRU (in UL) or network (in DL) via one or more QoS/data flows. In this regard, the different QoS flows carrying the PDUs/PDU sets associated to an XR application/experience may be visible to the AS-layers (e.g., with associated IDs) and/or handled at the AS layers with the awareness of the association during data transmission and reception.

In one or more examples herein, WTRU actions, possibly related to application actions and/or AS-layer actions for ensuring/supporting differentiated QoS, may correspond to any of the following: determining of metadata of application (e.g., XR application); determining/generation of application content; performing measurements and reporting; handling/forwarding of data/PDUs/PDU sets and handling QoS associated with PDUs/PDU sets; handling/forwarding of information related to connectivity with network and/or other WTRUs.

WTRU actions, possibly related to application actions and/or AS-layer actions for ensuring/supporting differentiated QoS, may include determining of metadata of application (e.g., XR application). For example, determining metadata may involve determining any of the FoV/visual/spatial perimeters, 2D/3D size, border, spatial attributes and boundaries of FoV, based on measurements in any spatial dimensions, including but not limited to longitude, latitude, altitude, depth, roll, pitch, yaw in one or more coordinate systems (e.g., cartesian, spherical). For example, determining metadata may involve determining the quality of the FoV content, e.g., whether the FoV content is of high quality (which in the case of an image, may be quantified and assessed by the image resolution (e.g., number of density of megapixels)). For example, determining metadata, may involve determining the importance and/or priority of the FoV content. The importance may be associated with the spatial importance and/or temporal importance of content/data, for example. For example, the spatial/temporal importance value may indicate the absolute or relative importance associated with the FoV content. Spatial importance may be associated with one or more segments/tiles/slices/positions of FoV in spatial dimension, for example. Temporal importance may be associated with one or more frames/subframes of FoV in time dimension, for example.

WTRU actions, possibly related to application actions and/or AS-layer actions for ensuring/supporting differentiated QoS, may include determining/generation of application content. For example, determining of application content may involve determining/capturing the one or more 2D/3D images/video frames associated with an FoV boundary/perimeter/border as defined by the FoV metadata by the WTRU/node for itself and/or on behalf of another WTRU/node. For FoV content mapping, the WTRU may determine the images/video frames using visual sensors (e.g., 2D/3D camera, lidar), RF sensors (e.g., RF transceiver, RADAR), audio sensors (e.g., sonar), etc. Herein, the mapping of FoV may also be referred to as sensing of FoV content or capturing of FoV content. For example, determining of application content may also include recording/capturing of audio frames, either as part of the real environment or as part of an overlaid sound-track/audio file with the audio file originating from a source other than the current real environment being mapped.

WTRU actions, possibly related to application actions and/or AS-layer actions for ensuring/supporting differentiated QoS, may include performing measurements and reporting. For example, the WTRU may perform measurements of positioning/spatial/pose (e.g., 6DoD/3DoD orientation, location/position), rate of motion/movement, etc. of the user/WTRU and/or other objects (e.g., virtual or real) which the user may be interacting with. The WTRU may send/report the pose measurements to network, periodically or when detecting event triggers (e.g., change in pose measurements above/below a threshold). For example, the WTRU may perform measurements of one or more of reference signals or channels (e.g., synchronization signal block (SSB), channel state information-reference signal (CSI-SR), positioning reference signal (PRS), sidelink reference signal (sidelink RS), global navigation satellite system (GNSS) signals, unlicensed carriers, ultra-wideband signals, LIDAR signals, visual signals, etc., for example. In another example, the WTRU may perform measurements of the radio link interfaces associated with the WTRU (e.g., Uu link, SL). WTRU may trigger transmission and/or measurement of reference signals in other one or more WTRUs (e.g., via Uu link and/or sidelink), for example. WTRU may send measurement report to network and/or another WTRU.

WTRU actions, possibly related to application actions and/or AS-layer actions for ensuring/supporting differentiated QoS, may include handling/forwarding of data/PDUs/PDU sets and handling QoS associated with PDUs/PDU sets. For example, data may include any of media/image/video frames, sensor data, and measurement data (e.g., pose measurements, link/channel measurements) determined by WTRU, possibly for supporting an application/service/network request associated with the WTRU. For example, the WTRU may send and/or receive data, to/from one or more destinations including RAN node (e.g., gNB), CN function/entity, application function (e.g., hosted in WTRU or in network). For example, the WTRU may perform splitting/merging of data/PDUs in one or more QoS flows into one or more forwarding configurations during transmission/receptions.

WTRU actions, possibly related to application actions and/or AS-layer actions for ensuring/supporting differentiated QoS, may include handling/forwarding of information related to connectivity with network and/or other WTRUs. A WTRU may sending capability information to network, including capability for supporting one or more traffic flows with different XR traffic patterns (e.g., periodic/aperiodic, PDU sets with variable payload sizes), capability for performing application layer measurements (e.g., QoE measurements, application buffer measurements, RTT measurements), and capability for detecting changes to traffic patterns, for example. The WTRU may send inter-WTRU coordination capability information to network, including capability for supporting one or more interfaces, capability to coordinate and/or interact with other WTRUs/devices (e.g., via SL interfaces), which may be co-located or non co-located with the WTRU, for example. The WTRU may receive configuration, including receiving radio resource control (RRC) configuration from gNB and/or NAS-layer configuration from CN. The WTRU may send and/or receiving assistance data to/from network associated with traffic, QoS, scheduling, etc., for supporting UL/DL transmissions. The WTRU may send requests for radio resources and/or resource grants (e.g., dynamic grants, semi-static/configured grants).

One or more of the following features or components as described herein may be applicable to one or more examples herein: information on XR traffic; information on the traffic characteristics; WTRU receiving configuration information from a network; congestion; WTRU detecting a flag for PDU set handling (e.g., PSIHI) or identifying a data type; one PDCP discard timer or multiple PDCP discard timers; WTRU discard behavior based on discardTimer; WTRU discard behavior based on factors other than expiry of discard timer of a data unit (e.g., discard timer of a dependent data unit, data type, etc.).

Information on XR traffic may include one or more of the following. Information on XR traffic may include association information (e.g., information on dependency). Dependency may refer to both intra-PDU set dependency (e.g., dependency between different PDUs of a PDU set) or inter-PDU set dependency (e.g., dependency between multiple PDU sets). Dependency may refer to dependency between different PDU sets in a data burst (e.g., different PDU sets received within a short time window).

Dependency may be determined by or known/communicated to the WTRU based on one or more of the following: importance markings (e.g., importance markings added at the application or service data adaptation protocol (SDAP) or a new layer above/below the SDAP), SN markings (e.g., SN markings added at the application or SDAP or a new layer above/below the SDAP), arrival times, data type, QoS flow, explicit indication(s) from higher/application layer.

Dependency may be determined by or known/communicated to the WTRU based on importance markings. Importance markings may be added, for example, at the application or SDAP or a new layer above/below the SDAP. For example, the Importance markings may be added to the data unit (e.g., in the header of each PDU set) or sent as metadata (e.g., via separate signaling). The lower layers may be able to read the importance marking and infer the (e.g., any) dependencies from the importance marking.

Dependency may be determined by or known/communicated to the WTRU based on SN markings. Sequence number (SN) markings may be added, for example, at the application or SDAP or a new layer above/below the SDAP. The SN markings may be added to the data unit (e.g., in the header of each PDU set) or sent as metadata (e.g., via separate signalling). The lower layers may be able to read the SN marking and infer the (e.g., any) dependencies from the importance marking. For example, PDUs 1,2,3 of PDU set 1 may be marked as [1,1], [1,2], [1,3] and PDUs 1,2 of PDU set 2 may be marked as [2,1], [2,2].

Dependency may be determined by or known/communicated to the WTRU based on arrival time(s). Arrival time(s) may be used based on time keeping (e.g., time keeping at SDAP/PDCP, with regards to time reference (e.g., SFN)), time window (e.g., start/end time). For example, the lower layers may assume dependencies within two data units (e.g., two PDU sets) that arrive within a time window of each other.

Dependency may be determined by or known/communicated to the WTRU based on data type(s). Subsequent frames may depend on a first one or more frames (e.g., a second frame depending on a first frame), for example, if the data type associated with the subsequent frames is the same as the data type associated with the first one or more frames. A first frame type may depend on a second frame type, for example, if a data type associated with the first frame type and a data type associated with the second frame type is the same. For example, dependent/differential frame (e.g., P-/B-frame) may depend on an I-frame. In examples, one PDU set type I has higher dependencies between the constituent PDUs of the PDU set (e.g., since by definition, PDU set type I cannot tolerate any loss/delay of any PDU in the PDU set, as compared to PDU set type II which may tolerate loss/delay of one or more PDUs in the PDU set).

Dependency may be determined by or known/communicated to the WTRU based on a QoS flow. For example, a WTRU may determine that multiple (e.g., two) PDU sets that arrive in the same QoS flow are dependent on each other.

Dependency may be determined by or known/communicated to the WTRU based on explicit indication(s) from higher/application layer. For example, the higher/application layer may explicitly mark two data units that are dependent on each other since the application may require both data units at the other end. For example, the application may mark PDU set 1 and PDU set 3 as dependent on each other (e.g., via in-band marking of PDU set 1 and PDU set 3 or via separate signalling indicating dependencies between PDU set 1 and PDU set 3) so that the lower layers in the WTRU (e.g., AS layers) can treat PDU set 1 and PDU set 3 in a way to maintain the dependencies. In examples, the higher/application layer may provide an application layer packet. The packet may be considered a PDU. The application layer packet may be an RTP packet. The packet may include a header that describes the PDU. There may be a field in the header that indicates the priority (e.g., the importance) of the packet relative to other packets of the same stream. The WTRU may determine that packets with the same priority value in the header are dependent on one another. There may be a field in the header that indicates a sequence number. The WTRU may determine that PDU sets that are associated with consecutive sequence numbers are associated with one another (e.g., a PDU set that is associated with sequence number 4 and a PDU set that is associated with sequence number 5 are associated). There may be a field in the header that indicates dependency. For example, dependency indication may be called a correlation ID and PDU sets that include the correlation ID in the header may be considered dependent on one another. In some examples, the WTRU may receive PDU set handling rules in a NAS message. The PDU set handling rules may be received as part of a QoS rule. The PDU set Handling rules may indicate correlation ID values that are to be considered to be associated with one another. For example, the PDU set Handling rules may indicate that Correlation ID values 5 and 3 are associated. The WTRU may then determine that any packets with a Correlation ID of 3 or 5 in the header are associated with one another.

Dependency may be determined by or known/communicated to the WTRU based on one or more of the examples herein. For example, the WTRU may determine that multiple (e.g., two) PDU sets of the same importance that are sent consecutively (or within a short specified time window of each other) are dependent on one another. The WTRU may determine that multiple (e.g., two) PDU sets of the same type with arrival times within a short time window of each other are dependent.

A WTRU may send information (e.g., to the NW) or receive information (e.g., from the higher layers (e.g., application layer(s)) or from the NW) or determine information on the traffic characteristics. Information on the traffic characteristics may include on or of the following. Information on the traffic characteristics may include one or more of the following: the PDU set size, the number of PDUs per PDU set, the number of PDUs in data burst in one or more traffic flows. Information on the traffic characteristics may include instantaneous measurements/determination and/or statistical/distribution information such as mean, minimum, maximum, standard deviation values. Information on the traffic characteristics may include the information related to PDU set(s). The information related to PDU set(s) may include the size(s) of the PDU set(s) (e.g., the total payload, the number of PDUs in the PDU set(s)), an indication of start/first and/or end/last PDU of the PDU set(s), and an indication of the association/dependency of the PDUs in a PDU set(s) (e.g., an ID of PDU set, importance/priority value).

The information on the traffic characteristics may be obtained. In examples, the WTRU may receive from higher layers (e.g., application layer(s)) or derive information on the importance of the data it receives from the higher/application layer. A WTRU may receive PDU sets with an indication (e.g., a marking/flag) indicating that they are ‘important’ PDU sets. For example, a ‘1’ indicating important and a ‘0’ indicating not important. There may be different levels/granularities to define importance. The WTRU may receive information from the higher/application layer on how important a PDU set is. For example, a ‘11’ indicating very important, a ‘10’ indicating average importance, a‘01’ indicating low importance and a ‘00’ indicating not important. There may be further granularities defined. The WTRU may read the importance value in, for example, the header of the PDU set. The WTRU may receive a separate PDU (e.g., a control PDU) which provides information on the importance of some PDU sets. For WTRU traffic, the WTRU may send information on the importance of the PDU sets to the network. In examples, a WTRU may receive information (e.g., from the XR application) on the number of PDUs in a PDU set and an indication of the first PDU in the PDU set. Based on these pieces of information, the WTRU may determine the size of the PDU set and the last PDU of the PDU set. In examples, the WTRU may have received PDUs 1,2,3 from a PDU set. Based on information on the PDU set size (e.g., in terms of the total number of PDUs in the PDU set), the WTRU may determine that PDUs 4,5,6 of the PDU set are still pending and is to be received soon (e.g., ideally within a time window that may allow the WTRU to transmit all the PDUs in the PDU set within the PSDB). In examples, the WTRU may send to a NW or receive from the NW/application/higher layers information on PDU sets and/or data bursts in one or more data/QoS flows, including one or more of: the number of PDUs or PDU sets (e.g., instantaneous, mean, max, min), payload size of PDU sets and/or data burst in units of bits/bytes (e.g., instantaneous, mean, max, min), periodicity, importance/priority, start and end indication of a PDU set and/or data burst (e.g., ID of first PDU/PDU set, ID of last PDU/PDU set), and dependency information within PDU set and/or data burst and across multiple PDU sets and/or data bursts (e.g., indicating whether multiple PDU sets are dependent on one another and/or whether PDU sets in one or more data bursts are dependent and/or whether PDUs within a PDU set are dependent on one another, etc.). In examples, the WTRU may send information related to the jitter in UL and/or in DL. Such jitter information which may be sent on a per flow, per-PDU set or per PDU basis, may include one or more of: the range, mean, maximum and minimum value, for example. In examples, the WTRU may send information on the importance/priority of any of the data units (e.g., PDUs, PDU sets, data bursts) to be transmitted/received in UL/DL. In examples, a WTRU may receive indication(s) (e.g., from a NW or higher/application layer) on changes in the traffic pattern characteristics and/or may send indications when detecting changes in the UL/DL traffic patterns (e.g., changes in payload size, PDU set sizes, data burst sizes, jitter range, periodicity etc.). In examples, a WTRU may send configuration to the NW via any one or more of: RRC signalling and/or NAS messages (e.g., SRB0, SRB1, SRB2, SRB3, SRB4), control PDUs associated with any of the AS layers (e.g., SDAP control PDU, PDCP control PDU), UL MAC CE (e.g., existing MAC CE, new MAC CE, regular BSR, periodic BSR, enhanced BSR, padding BSR, pre-emptive BSR, etc.), UCI (e.g., single bit SR, multi-bit SR, feedback, acknowledgement (ACK)/negative ACK (NACK), CSI report), PUCCH, PUSCH, non-AS (NAS) layer signalling (e.g., PDU session related messages), or application layer signalling/messages.

A WTRU may receive configuration information from a network. The WTRU may receive from a base station (e.g., from gNB and in RRC) a set of DRBs configured by the base station (e.g., DRB1, priority of DRB1, DRB2, priority of DRB2). The WTRU may receive from the base station (e.g., the gNB), for example, rules/restrictions for mapping of DRB to LCH and/or mapping of DRB and/or LCH to resource grants (e.g., CG). The WTRU may receive from the base station (e.g., the gNB in RRC) a set of LCHs out of which some LCHs may be configured to handle dependencies. The LCH parameters (e.g., BSD, PBR, priority) may apply for all or some of the data units (e.g., PDUs and/or PDU set and/or data bursts) mapped to the LCH. The WTRU may receive, from a base station (e.g., a gNB) LCP configurations and/or changes in LCP configurations (e.g., LCP restrictions/rules/configurations for handling of PDUs/PDU sets/data bursts) for a certain time duration or indefinitely or until further notice (e.g., a change in LCP configuration). The WTRU may receive from the base station (e.g., the gNB) indication(s) on whether these LCP rules may be relaxed/changed temporarily for a time duration or whether they may be applied (e.g., always applied). The WTRU may receive from the gNB configuration(s) for multiplexing PDUs/PDU sets/Data bursts into transport blocks. The WTRU may receive configuration from the NW via any one or more of: RRC signalling and/or messages (e.g., dedicated/unicast signalling via any of SRBs, broadcast/SIB), control PDU(s) associated with one or more (e.g., any) of the AS layers (e.g., SDAP control PDU, PDCP control PDU), DL MAC CE, downlink control information (DCI), PDCCH, PUSCH, Non-AS (NAS) layer signalling (e.g., a PDU Session Establishment Response or a PDU Session Modification Command), or Application layer signalling/messages.

A congestion may be detected. In some cases, one or more of the examples (e.g., including enhancements to discard mechanisms) may apply (e.g., only apply) to cases where congestion is detected. Congestion may be detected at the WTRU and/or the base station (e.g., a gNB), for example, based on one or more of the following: a throughput, block error rate (BLER), hybrid automatic repeat request (HARQ) ACK/NACK, ARQ ACK/NACK, status report/feedback/confirmation or lack thereof at any layer in the protocol stack indicating successful and/or unsuccessful delivery, an acknowledgement of a reception or lack thereof at any layer in the protocol stack, time of reception of traffic, etc. In examples, time of traffic arrival at the WTRU later than the expected time of arrival may indicate congestion. A large number of HARQ NACKs (e.g., a number of HARQ NACKs is greater than a threshold) within a preconfigured window may constitute a trigger for congestion detection at the WTRU. A low number of status reports (e.g., a number of status reports that is less than a threshold) confirming successful delivery at the receiving side may constitute a trigger for congestion detection at the WTRU. The WTRU may receive an indication from the network and/or application indicating a presence of congestion.

In one or more examples herein, PDU set 1 may refer to one or more PDU sets with similar PDU set level QoS requirements (e.g., same or similar PSDB1, PSER1, PSII indication, etc.). PDU set 2 may refer to one or more PDU sets with similar PDU set level QoS requirements (e.g., same or similar PSDB2, PSER2, PSII indication, etc.). In one or more examples herein, PDCP may refer to the packet data convergence protocol entity/layer in a WTRU (or any new entity/layer in the WTRU that performs the task of transmitting/discarding of data unit). It may be assumed that there may be a similar/corresponding entity/layer at a base station (e.g., the gNB).

A WTRU may detect an indication (e.g., a flag) for PDU set handling (e.g., PSIHI) and/or may identify data type(s). Based on the SA2 definition of the PDU set, a PDU set may be used for handling and delivering of a group of PDUs belonging to the PDU set. Some PDU sets may be capable of tolerating some loss and/or delay of one or more PDUs in the PDU set (e.g., the XR application can still reconstruct the PDU set with delay/loss of one or more PDUs in the PDU set). Such PDU sets are referred to as Type II PDU sets in one or more examples herein. Some PDU sets (e.g., referred to as Type I PDU set in one or more examples herein) may not (e.g., cannot) tolerate any loss/delay of PDUs in the PDU set, for example, the XR application cannot tolerate any delay/loss of any PDU in the PDU set such that if there is any delay/loss of any PDU in the PDU set, the remaining PDUs in the PDU set may be dropped. Such PDU sets may be referred to as PSIHI PDU sets or PDU sets with PSIHI indicator(s) in one or more examples herein.

In examples, it may be up to the XR application to determine whether reconstruction of PDU sets can happen or not with some loss/delay. It may be the XR application that marks the PDU sets as Type I or Type II. The marking may be done at the NAS layers or at the AS layers (e.g., SDAP). This information may be communicated/relayed down to the lower layers so that the lower layers (e.g., PDCP) may adapt the handling (e.g., discarding) of the PDU set accordingly. One or more of the following may occur. In examples, the information (e.g., the marking) may be added to a (e.g., each) PDU set (e.g., as a marking in the header of each PDU set) and the lower layers in the WTRU (e.g., PDCP) may be able to read it. In examples, the information may be added to a PDU set and the lower layers may assume that similar information applies to the (e.g., all) subsequent PDU sets (e.g., all subsequent PDU sets without marking are of the same type as the one PDU set with the marking), until a PDU set with a different marking reaches the lower layers. In examples, the type of PDU set and the number of subsequent PDU sets (e.g., N) of the same type may be marked in the header of a first PDU set. The lower layers, upon receiving/reading the header of this first PDU set may provide a similar treatment to the N subsequent PDU sets, for example, without spending time reading the header of the subsequent N PDU sets. In examples, this information may be sent separately as metadata to the lower layers in the WTRU. In examples, PDU sets of a type may carry a flag (e.g., one-bit flag) to identify the type. For example, only type I PDU sets may carry a flag that indicates that the XR application cannot tolerate any loss/delay of any PDU in the PDU set. In examples, the first type I PDU set may carry a flag to indicate its type. The lower layers may assume that the subsequent PDU sets are also type I. In examples, PDU sets of a certain importance may be assumed to be of a certain type by the WTRU. For example, the WTRU may assume that any PDU set with an importance value greater than a certain pre-set value (e.g., greater than 8 on an importance scale of 1-10 with 10 being most important) is a Type I PDU set (and therefore cannot tolerate any loss/delay of any PDU of the PDU set). The importance of the PDU set may be determined by the XR application and communicated to the WTRU either in-band (e.g., in the header of a PDU set) or in separate signalling (e.g., metadata signalling). In examples, the application may define a new parameter for the usage of the PDU set at the application. The new parameter may be, for example, a PDU set QoS parameter that may indicate the preferred treatment of the PDU set at the lower layer, e.g., PSII (PDU set Integrated Indication) that indicates whether all PDUs are needed for the usage of the PDU set at the application. The parameter may be binary (e.g., all PDUs needed without any loss/delay or not) or more granular (e.g., a certain number/percentage of PDUs of a PDU set is needed for the reconstruction of the PDU set at the application). The parameter may be signalled to the lower layers via marking of PDU sets (e.g., in-band marking in a header) or via separate signalling (e.g., signalling dedicated for metadata on PDU sets).

One or more PDCP discard timers may be used. In some PDCP frameworks (e.g., a legacy PDCP framework), there may be one discard timer associated with each PDCP SDU. When the discardTimer expires for a PDCP SDU, or the successful delivery of a PDCP SDU is confirmed by PDCP status report, the transmitting PDCP entity discards the PDCP SDU along with the corresponding PDCP Data PDU. With XR traffic including one or more PDUs in a PDU set and one or more PDU set in a data burst with dependencies between constituent PDUs in a PDU set or constituent PDU sets in a data burst, the following one or more examples may be considered when configuring the PDCP discard timer. In examples, there may be one PDCP discardTimer that is operated per PDCP SDU as in some PDCP framework where the expiry of the timer takes into account the PDU delay budget (PDB) of the individual PDU. This configuration may imply multiple PDCP discardTimers per PDU set. In examples, there may be one PDCP discardTimer that is operated per PDCP SDU as in some PDCP framework but in this configuration, the expiry of a constituent timer of a PDU set takes into account the PSDB of the PDU set (e.g., each constituent timer of each PDU set takes into account the PSDB of the PDU set and not the PDB of the individual PDU). This configuration may imply multiple PDCP discardTimers per PDU set (e.g., all with expiry time corresponding to the PSDB of the PDU set). In examples, there may be one PDCP discardTimer that is operated per PDCP SDU as in some PDCP framework but in this configuration, different lengths of PDCP discard timers (e.g., taking into account the PSDB) are applied for SDUs of the same PDU set to make them expire at the same time (e.g., all expire at the same time), if the PDUs of the PDU set do not all arrive at the WTRU at the same time. For example, a first batch of PDUs of a PDU set (e.g., that arrived at a time t1) may have a larger discardTimer expiry time value compared to a second batch of PDUs of a PDU set (e.g., that arrived at a time t2, where t2 is greater than t1). In examples, there may be one PDCP discardTimer that is operated per the PDU set, which takes into account the PSDB of the PDU set. In examples, more than one configuration may be possible. For example, a base station (e.g., the gNB) may configure whether the PDCP discardTimer is operated per PDCP SDU or per PDCP PDU set. A WTRU may determine which option to use (e.g., PDCP discardTimer operated per PDCP SDU or per PDCP PDU set) and/or how to configure the expiry timer value (e.g., based on PDB of individual PDU or based on PSDB of PDU set or based on PSDB of PDU set with increments/decrements according to arrival times at WTRU) based on, for example, whether all PDCP SDUs belonging to a PDU set arrive at the same time or in a staggered way. In one or more examples herein, PDCP discardTimer of XR data unit may be used to describe a discard timer per PDCP SDU or per PDU set according to any one or more of the options described above.

WTRU discard behavior(s) may be based on discardTimer. The discard behavior at the WTRU (e.g., at PDCP layer in WTRU) may be on a PDU basis or on a PDU set basis. For example, if there is one discardTimer per PDCP SDU for each SDU of a PDU set, each PDCP SDU is discarded at the expiry of its respective discardTimer (whether that discardTimer is based on the individual PDB of the PDU/PDCP SDU or the PSDB of the PDU set it is part of). If there is one discardTimer per PDU set, at the expiry of the discardTimer, the transmitting PDCP entity (e.g., WTRU for UL traffic) discards any PDU of that PDU set that has not been successfully transmitted. In the event there is a discardTimer associated with each PDCP SDU as well as a discardTimer associated with the PDU set, the WTRU may determine to prioritize the more stringent of the two conditions (e.g., prioritize the smaller of PDB or PSDB).

WTRU discard behavior(s) may be based on factors other than the expiry of discard timer of data unit (e.g., discard timer of a dependent data unit, data type, etc.) The discard behavior(s) at the WTRU (e.g., at PDCP layer in WTRU) may be based on the data type or an (e.g., any) indication from higher/application layer on the preferred handling of the XR data unit, for example, in addition to the discardTimer value. The discard behavior(s) may be configured at an entity (e.g., PDCP entity) at any AS layer in the WTRU (e.g., at the PDCP layer in the WTRU) or at an entity (e.g., a new entity) at a new layer in the WTRU. Example of a new layer may be a new layer between the SDAP and PDCP layers in the WTRU which may be common to multiple PDCP entities in the WTRU.

The WTRU discard behaviour of a data unit (e.g., PDU set 1) may be a function of one or more of the following: discard timer(s) of the data unit, discard timer(s) of one or more constituent part(s) of the data unit, discard timer(s) of a dependent data unit, importance of PDU set 1, status report to indicate successful delivery of XR data unit, status report to indicate successful delivery of a dependent XR data unit, status report to indicate successful delivery of another XR data unit on which the XR data unit is dependent, status report to indicate unsuccessful delivery of XR data unit, status report to indicate unsuccessful delivery of a dependent XR data unit, status report to indicate unsuccessful delivery of another XR data unit on which the XR data unit is dependent. The WTRU discard behaviour of a data unit may be a function of discard timer(s) of the data unit that has expired or is within a small preconfigured time window of expiring. For example, the discard timer associated with PDU set 1 has expired or is within a small preconfigured time window of expiring. The WTRU discard behaviour of a data unit may be a function of discard timer(s) of one or more constituent part(s) of the data unit that has expired or is within a small preconfigured time window of expiring. For example, the discard timer of one or more PDUs of PDU set 1 may have expired or be within a small preconfigured time window of expiring. The WTRU discard behaviour of a data unit may be a function of discard timer(s) of a dependent data unit that has expired or is within a small preconfigured time window of expiring. For example, the discard timer of PDU set 2 which is dependent on PDU set 1 and/or which PDU set 1 depends on may have expired or be within a small preconfigured time window of expiring.

The WTRU discard behaviour of a data unit may be a function of importance of PDU set 1. In examples, if the importance of a PDU set is above a threshold, the WTRU may determine to not discard the PDU set even if the PSDB has expired (e.g., because the PDU set may still be needed for the decoding of dependent PDU sets). In examples, if the PDU set importance is above a threshold or the PDU set has a flag to indicate that it is important, the WTRU (e.g., PDCP) may be configured to not discard the PDU set even if the discardTimer corresponding to the PDU set has expired, if the WTRU has not received a status report confirming successful reception of that PDU set from the network. In examples, if the PDU set importance is above a threshold or the PDU set has a flag to indicate that it is important, the WTRU (e.g., PDCP) may be configured to scale up the length of the discardTimer for that PDU set. For example, if importance of PDU set=A₁, a scaling factor X2 may be applied to the length of the discardTimer applied to the PDU set. If importance of PDU set=A₂, a scaling factor X3 may be applied to the length of the discardTimer applied to the PDU set, and so forth. The WTRU may receive the association between the scaling factor to apply and the PDU set importance from the network. In examples, if the PDU set importance is above a threshold or the PDU set has a flag to indicate that it is important, the WTRU (e.g., PDCP) may be configured to extend the corresponding PDCP discardTimer to apply to that PDU set. The WTRU may be configured with one or more of the following: a maximum number of times it can extend the discardTimer value (e.g., for an important PDU set of importance A1, the WTRU may only be able to extend the discardTimer value 2 times maximum); a maximum buffer fill rate beyond which it cannot extend the discardTimer value anymore (e.g., for an important PDU set of importance A1, the WTRU may only be able to extend the discardTimer value up until the PDCP buffer is filled at 80%. If it fills up more than 80%, the WTRU cannot extend the discardTimer value anymore).

The WTRU discard behaviour of a data unit may be a function of status report to indicate unsuccessful delivery of another XR data unit on which the XR data unit is dependent. In examples, if the PDCP discard timer(s) for the XR data unit has expired or is within a small preconfigured time window of expiring and/or data type=PDU set type I (e.g., application cannot reconstruct the PDU set with delay/loss of any PDU of PDU set), the WTRU may discard the XR data unit or copies of the XR data unit. The XR data unit may be an entire PDU set or some PDUs of a PDU set. In examples, if the PDCP discard timer(s) for the XR data unit has expired and/or data type of the XR data unit=PDU set type I and/or the WTRU (e.g., transmitting PDCP entity in WTRU) has received a status report from gNB (e.g., receiving PDCP entity in gNB) to indicate unsuccessful delivery of the XR data unit and/or there are dependencies between this XR data unit and another XR data unit (e.g., another PDU set mapped to a different DRB/PDCP entity), the WTRU may send an indication to the one or more PDCP entities with the dependent data unit to drop the (e.g., all) copies of the dependent data unit. For example, the WTRU may have determined dependencies between PDU set 1 and PDU set 2, such that without PDU set 1, PDU set 2 may be useless. For example, PDU set 1 may be an I-frame and PDU set 2 may be a differential P-/B-frame. If the PDCP discard timer(s) for PDU set 1 has expired AND the WTRU (e.g., PDCP) has received a status report from gNB indicating unsuccessful delivery of one or more PDUs of PDU set 1, and the data type of PDU set 1 is a PDU set type I which cannot tolerate any loss/delay of any PDU of the PDU set for the successful reconstruction of the PDU set, the WTRU (e.g., transmitting PDCP entity 1 carrying copies of PDU set 1) may send an indication to PDCP entity 2 (carrying copies of PDU set 2) to drop the (e.g., all) copies of PDU set 2 and/or any PDUs of PDU set 2 since PDU set 2 depends on the successful reconstruction of PDU set 1.

In examples, if the dependent PDU set has already been submitted to the lower layers (e.g., WTRU RLC entity), the WTRU (e.g., PDCP entity) may send a discard indication to the lower layers (e.g., RLC entity) to avoid a gap in sequence numbering (e.g., any gap in any sequence numbering). In these examples, if the dependent PDU set 2 has already been submitted from PDCP entity 2 to RLC entity 2, PDCP entity 2, on reception of an indication from PDCP entity 1, indicating that the discard timer(s) of PDU set 1 has expired, and one or more or all PDUs of PDU set 1 was not successfully delivery to the gNB, may send an indication to RLC entity 2 to avoid a gap in sequence numbering (e.g., any gap in sequence numbering). Following reception of this indication at RLC entity 2 from PDCP entity 2, RLC entity 2 may send an indication to a base station (e.g., the gNB) or to the lower layers to indicate that PDU set 2 is no longer useful. The indication may contain the reason(s) (e.g., due to unsuccessful delivery of part or all of PDU set 1 or due to anticipated unsuccessful reconstruction of PDU set 1 as a result of some or more or all PDUs of PDU set 1 having incurred delay/loss).

Some layers or entities may be common to multiple PDCP entities in the WTRU. An example of a new layer may include a new layer between the SDAP and PDCP layers in the WTRU which may be common to multiple PDCP entities in the WTRU. For example, in a model where a (e.g., each) type of PDU set may be mapped to a different DRB (and therefore different PDCP entity) and there is a dependency between two or more such different PDU sets (e.g., mapped to different PDCP entities), the common layer above the PDCP entity (e.g., the existing PDCP entity) may be used for one or more of the following. The common layer may have visibility of the dependent PDU sets and the PDCP entities they are mapped to (e.g., all the dependent PDU sets and the PDCP entities they are mapped to). The common layer may send an indication to the PDCP entities with dependent PDU sets (e.g., all PDCP entities with dependent PDU sets) to inform them about the dependencies. The common layer may receive indication(s) from the base station (e.g., the gNB), for example, status report to indicate successful, unsuccessful delivery of data unit and/or indication(s) to drop a (e.g., any) data unit or dependent data unit. The common layer may send an indication to the PDCP entities with dependent PDU sets (e.g., all PDCP entities with dependent PDU sets) informing them of successful/unsuccessful delivery indication(s) from the base station (e.g., the gNB). The common layer may handle one or more discard timer and/or have visibility of the discard timer(s) at the one more PDCP entities. The common layer may determine dependencies between data units (e.g., between PDU set 1 and PDU set 2). The common layer may send a discard indication to a PDCP entity to drop a dependent data unit (e.g., to PDCP entity 2 to drop PDU set 2 following status report from the base station (e.g., the gNB) indicating unsuccessful delivery of PDU set 1).

In one or more examples herein, following a discard of a dependent PDU set, the WTRU may send an indication to the base station such as a gNB (e.g., corresponding PDCP entity in gNB) to inform the base station of the discard. The indication may include ways to identity the PDU set that was discarded and/or a (e.g., any) context associated with the PDU set that was discarded (e.g., Serial number, Sequence number, etc.). In examples, the WTRU may determine that PDU set 1 and PDU set 2 are dependent. The WTRU may discard PDU set 2 if the discard timer(s) for PDU set 1 has expired and PDU set 1 was not successfully transmitted to the base station (e.g., the WTRU may have received a status report from the gNB indicating unsuccessful delivery of PDU set 1 or a request from the gNB to resend PDU set 1).

One or more of the following features such as polling at PDCP or polling at RLC may be used in association with one or more examples as described herein (e.g., the examples on polling at PDCP and/or the examples on polling at RLC).

Polling may occur at a PDCP level associated with a WTRU (e.g., as described in one or more examples herein on polling). In examples, a WTRU (e.g., a transmitting PDCP entity in the WTRU) may receive configuration information (e.g., from the network) indicating, for example, a configuration on polling. Such configuration may include timers and/or one or more of condition(s), rule(s), or threshold(s) on, for example, whether and/or when to trigger polling at PDCP. The WTRU may trigger polling (e.g., at a PDCP level associated with a WTRU) by sending a polling indicator. For example, the polling indicator may be sent in a PDCP packet or in a PDCP header. The WTRU may receive and/or determine a time period (e.g., a timer/time window) which, on expiry, may trigger a polling indicator (e.g., may trigger a determination that the polling indicator is to be sent). In examples, a polling indicator may be transmitted on expiry of the time period. For example, the time period (e.g., the timer value) may be standalone. The time period (e.g., the timer value) may be a function of various parameters (e.g., the PSDB and/or PDCP discardTimer). The WTRU may receive and/or determine, for example, one or more of condition(s), rule(s), or threshold(s) on, for example, whether and/or when to trigger polling. In examples, the WTRU may receive threshold(s) (e.g., a PDU set priority value Tₗ) corresponding to PDU set importance value(s) and/or importance level(s), for example, such that the WTRU may trigger polling at PDCP for PDU set(s) with importance value(s) greater than Tₗ (e.g., only trigger polling, at a PDCP level associated with the WTRU, for PDU set(s) with importance level(s) greater than threshold Tₗ). In examples, a PDU set priority may be used to indicate an importance level of the PDU set for an Xtended reality (XR) application (e.g., the lower PDU set priority value may indicate the higher priority or importance level of the PDU set). The WTRU may not trigger polling for PDU set(s) with importance level(s) equal to or less than threshold Tₗ. In some examples, the WTRU may receive thresholds corresponding to one or more PDU set parameters (e.g., one or more PDU set parameters other than PDU set importance level(s)). For example, the WTRU may receive a threshold corresponding to a PDU set delay budget (PSDB), a threshold corresponding to a PDU set error rate (PSER), etc. In some examples, the WTRU may receive configurations and/or rules to trigger polling for a type of PDU set (e.g., only trigger polling for a type of PDU set). For example, the type of PDU set may be type I PDU set (e.g., a PDU set that does not tolerate a loss or delay of any PDU in the PDU set).

The WTRU (e.g., transmitting PDCP in WTRU) may be configured to trigger polling (e.g., transmit a polling indicator) based on one or more of the following examples. The WTRU may be configured to send a polling indicator concerning a PDU set of a certain characteristic. In examples, the WTRU may be configured to trigger polling if a PDU set importance (e.g., as indicated by a PDU set priority) is greater than a threshold (e.g., a threshold received from the NW).

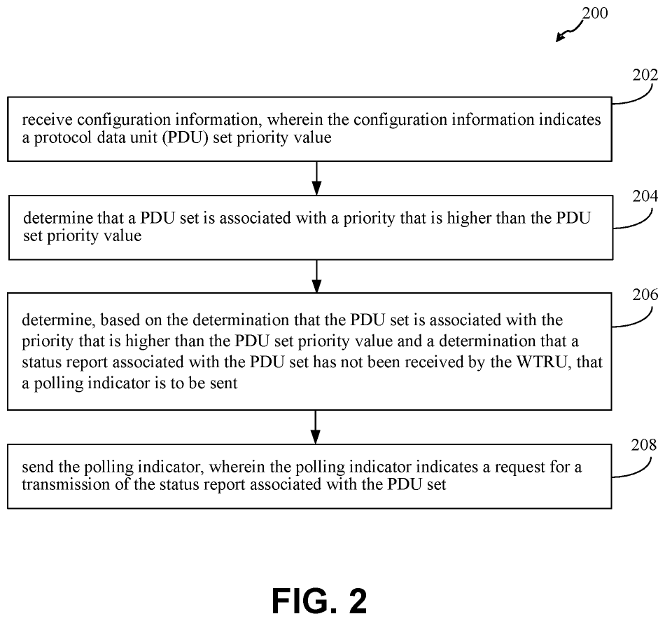

FIG. 2 is an example showing a determination to send a polling indicator and the transmission of the polling indicator. As shown in FIG. 2, a WTRU may receive configuration information that indicates a PDU set priority value at 202. The WTRU may determine that a PDU set is associated with a priority that is higher than the PDU set priority value at 204. If a status report associated with a PDU set (e.g., indicative of a reception of the PDU set) has not been received by the WTRU, the WTRU, at 206, may determine that a polling indicator is to be sent based on the determination that the PDU set is associated with the priority that is higher than the PDU set priority value. The WTRU may send the polling indicator at 208, and the polling indicator may indicate a request for a transmission of the status report associated with the PDU set. In some examples, the WTRU may be configured to trigger polling, for example, if PDU set is marked with an importance indicator (e.g., an importance flag). In some examples, the WTRU may be configured to trigger polling, for example, if PDU set is a PSIHI PDU set (e.g., marked with a PSIHI indicator).

The WTRU may be configured to trigger polling if the PDU set has not been received. In examples, the WTRU may be configured to trigger polling, for example, if the WTRU (e.g., Tx PDCP) has not received a status report associated with the PDU set (e.g., a status report indicating a successful delivery of the PDU set). In some examples, the WTRU may be configured to trigger polling, for example, if the WTRU (e.g., Tx PDCP) has received a status report indicating an unsuccessful delivery of the PDU set or part thereof.

The WTRU may be configured to trigger polling based on a buffer status associated with the WTRU. In examples, the WTRU may be configured to trigger polling if the buffer status at the WTRU (e.g., Tx PDCP buffer) is filled (e.g., the buffer status indicating a filled status). The WTRU may be configured to trigger polling, for example, if the buffer status at the WTRU (e.g., Tx PDCP buffer) is filled at a certain percentage.

The WTRU may be configured to trigger polling based on a size of the PDU set. In examples, the WTRU may be configured to trigger polling, for example, if the size of the PDU set is greater than a threshold. In some examples, the WTRU may be configured to trigger polling, for example, if the size of the PDU set is equal to or less than a threshold.

The WTRU may be configured to trigger polling based on a PSDB of the PDU set and/or a PSER of the PDU set. The WTRU may be configured to trigger polling, for example, if the PSDB of the PDU set is less than a threshold (e.g., a threshold received from the NW). The WTRU may be configured not to trigger polling, for example, if the PSDB of the PDU set is equal to or greater than the threshold. The WTRU may be configured to trigger polling, for example, if the PSER of the PDU set is less than or equal to a threshold (e.g., a threshold received from the NW). The WTRU may be configured to trigger polling, for example, if the number of PDUs of the PDU set not received or received in error (e.g., corrupted, received late) is greater than or equal to a threshold (e.g., a threshold received from the NW).

The WTRU may be configured to trigger polling based on a request (e.g., from the network and/or application layer). The WTRU may be configured to trigger polling, for example, if the WTRU receives a request to trigger polling for that PDU set or if the WTRU receives a request to trigger polling for that type of PDU set.

The WTRU may be configured to trigger polling based on a PDU reception rate associated with the PDU set. The PDU reception rate may indicate a number of PDUs of the PDU set that have been received or a percentage of PDUs of the PDU set that have been received. In examples, the WTRU may be configured to trigger polling, for example, based on the number of PDUs of PDU set received at time T at the WTRU (e.g., Tx PDCP). For example, the WTRU may be configured to trigger polling if the number of PDUs of the PDU set received at time T is greater than a threshold (e.g., a PDU reception threshold). The WTRU may be configured to trigger polling if the number of PDUs of the PDU set received at time T is equal to or less than a threshold (e.g., a PDU reception threshold). The WTRU may be configured to trigger polling, for example, based on the percentage of PDUs of PDU set received at time T. For example, the WTRU may be configured to trigger polling if the percentage of PDUs of the PDU set received at time T is greater than a threshold (e.g., the PDU reception threshold received from the NW). The WTRU may be configured to trigger polling if the percentage of PDUs of the PDU set received at time T is equal to or less than a threshold (e.g., the PDU reception threshold received from the NW). In some examples, the WTRU may be configured to trigger polling, for example, based on the total number of PDUs in the PDU set (e.g., if the total number of PDUs in the PDU set is greater than a threshold, and not triggered if the total number of PDUs in the PDU set is equal to or fewer than the threshold). The WTRU may be configured to trigger polling, for example, based on the size of a buffer at the WTRU (e.g., a PDCP buffer). For example, the WTRU may be configured to trigger polling if the size of the buffer is greater than a threshold (e.g., not to trigger polling if the size of the buffer is less than the threshold).

The WTRU (e.g., the transmitting PDCP in the WTRU) may send a (e.g., one per data unit granularity) polling indicator (e.g., a polling indicator, a polling bit, a polling flag, or a polling message) to the network (e.g., receiving PDCP at NW) on one or more of the following data unit granularities: per PDU (e.g., one polling indicator per PDU); per PDU set (e.g., one polling indicator per PDU set); part of a PDU set (e.g., the remaining PDUs (e.g., all the remaining PDUs) of the PDU set); part of a data burst (e.g., the remaining PDUs/PDU sets of the data burst); per data burst (e.g., one polling indicator per data burst); per group of PDUs (e.g., one polling indicator per group of PDUs); per group of PDU sets (e.g., one polling indicator per group of PDU sets); per group of data bursts (e.g., one polling indicator per group of data bursts); per bits/bytes/kbits/Mbits/Mbytes, etc. or group thereof; per n bits/bytes/kbits/Mbits/Mbytes (e.g., one polling indicator every n bits/bytes/kbits/Mbits/Mbytes), etc.

The WTRU may send the polling indicator (e.g., a polling indicator, a polling bit, a polling flag, or a polling message) in-band (e.g., in the header of the PDU and/or the PDU set) or separately. In examples, a separate PDU indicating polling for a specific data unit or group thereof, possibly with the data unit ID (e.g., with the PDU set ID)) may be sent.

The WTRU may receive one or more status reports after the WTRU sends the polling indicator. In examples, following transmission of the polling indicator, the WTRU (e.g., a Tx PDCP) may wait for a time period (e.g., a preconfigured time window) for the reception of one or more status report(s) from the NW.

The WTRU may discard a data unit after the WTRU receives an indication that the data unit has been received (e.g., at the Rx side). In examples, the WTRU may receive, after the polling indicator is sent, the status report indicative of the reception of the PDU set, determine that the PDU set has been received based on the status report; and discard the PDU set based on the determination that the PDU set has been received. In some examples, as soon as the WTRU (e.g., a Tx PDCP) receives a status report from the Rx side (e.g., an Rx PDCP) confirming a successful delivery of the data unit, the WTRU (Tx PDCP) may discard the data unit (e.g., a PDU set).

The WTRU may refrain from discarding a data unit until an indication has been received indicating that the data unit has been received. In examples, the WTRU (e.g., a Tx PDCP) may not perform discarding until it receives a status report from the Rx side (e.g., an Rx PDCP) confirming a successful delivery of the data unit. The status report may be (e.g., generated and/or sent) in response to the polling indicator sent by the WTRU, for example.

The WTRU may receive a status report per PDU or per PDU set. In examples, the WTRU (e.g., a Tx PDCP) may receive one status report indicating the successful or unsuccessful reception for a (e.g., each) PDU in the PDU set. In some examples, the WTRU (e.g., a Tx PDCP) may receive one status report indicating the successful or unsuccessful reception for the PDU set. For example, the status report may indicate the status for a (e.g., each) PDU in the PDU set, or the status report may indicate a ‘1’ if the (e.g., all) PDUs of the PDU set are successfully received and a ‘0’ if any PDU(s) of the PDU set has not been received.

Polling may occur at an RLC level associated with a WTRU (e.g., as described in one or more examples herein on polling). In examples, a WTRU (e.g., a transmitting RLC entity in the WTRU) may receive configuration information (e.g., from the network) indicating, for example, a configuration on polling. Such configuration may include timers and/or one or more of condition(s), rule(s), or threshold(s) on, for example, whether and/or when to trigger polling at RLC. The WTRU may trigger polling (e.g., at an RLC level associated with a WTRU) by sending a polling indicator. For example, the polling indicator may be sent in an RLC packet or in an RLC header. The WTRU may receive and/or determine a time period (e.g., a timer/time window) which, on expiry, may trigger a polling indicator (e.g., may trigger a determination that the polling indicator is to be sent). In examples, a polling indicator may be transmitted on expiry of the time period. For example, the time period (e.g., the timer value) may be standalone. The time period (e.g., the timer value) may be a function of various parameters (e.g., the PSDB). The WTRU may receive and/or determine, for example, one or more of condition(s), rule(s), or threshold(s) on, for example, whether and/or when to trigger polling. In examples, the WTRU may receive threshold(s) (e.g., a PDU set priority value Tₗ) corresponding to PDU set importance value(s) and/or importance level(s), for example, such that the WTRU may trigger polling at RLC for PDU set(s) with importance value(s) greater than Tₗ (e.g., only trigger polling, at an RLC level associated with the WTRU, for PDU set(s) with importance level(s) greater than threshold Tₗ). The WTRU may not trigger polling for PDU set(s) with importance level(s) equal to or less than threshold Tₗ. In some examples, the WTRU may receive thresholds corresponding to one or more PDU set parameters (e.g., one or more PDU set parameters other than PDU set importance level(s)). For example, the WTRU may receive a threshold corresponding to a PDU set delay budget (PSDB), a threshold corresponding to a PDU set error rate (PSER), etc. In some examples, the WTRU may receive configurations and/or rules to trigger polling for a type of PDU set (e.g., only trigger polling for a type of PDU set). For example, the type of PDU set may be type I PDU set (e.g., a PDU set that does not tolerate a loss or delay of any PDU in the PDU set).

The WTRU (e.g., a transmitting RLC in the WTRU) may be configured to trigger polling based on one or more of the following examples (e.g., the example shown in FIG. 2). The WTRU may be configured to send a polling indicator concerning a PDU set of a certain characteristic. In examples, the WTRU may be configured to trigger polling if a PDU set importance (e.g., as indicated by a PDU set priority) is greater than a threshold (e.g., a threshold received from the NW). In some examples, the WTRU may be configured to trigger polling, for example, if PDU set is marked with an importance indicator (e.g., an importance flag). In some examples, the WTRU may be configured to trigger polling, for example, if PDU set is a PSIHI PDU set (e.g., marked with a PSIHI indicator).

The WTRU may be configured to trigger polling, for example, if the WTRU (e.g., a transmitting RLC in WTRU) receives an indication to trigger polling from the higher layers (e.g., PDCP, SDAP, application/higher layers) in the WTRU.

The WTRU may be configured to trigger polling if the PDU set has not been received.

In examples, the WTRU may be configured to trigger polling, for example, if the WTRU (e.g., Tx RLC) has not received a status report associated with the PDU set (e.g., a status report indicating a successful delivery of the PDU set). In some examples, the WTRU may be configured to trigger polling, for example, if the WTRU (e.g., Tx RLC) has received a status report indicating an unsuccessful delivery of the PDU set or part thereof.

The WTRU may be configured to trigger polling based on a buffer status associated with the WTRU. In examples, the WTRU may be configured to trigger polling if the buffer status at the WTRU (e.g., a Tx RLC buffer) is filled (e.g., the buffer status indicating a filled status). The WTRU may be configured to trigger polling, for example, if the buffer status at the WTRU (e.g., a Tx RLC buffer) is filled at a certain percentage.

The WTRU may be configured to trigger polling based on a size of the PDU set. In examples, the WTRU may be configured to trigger polling, for example, if the size of the PDU set is greater than a threshold. In some examples, the WTRU may be configured to trigger polling, for example, if the size of the PDU set is equal to or less than a threshold.

The WTRU may be configured to trigger polling based on a PSDB of the PDU set and/or a PSER of the PDU set. The WTRU may be configured to trigger polling, for example, if the PSDB of the PDU set is less than a threshold (e.g., a threshold received from the NW). The WTRU may be configured not to trigger polling, for example, if the PSDB of the PDU set is equal to or greater than the threshold. The WTRU may be configured to trigger polling, for example, if the PSER of the PDU set is less than a threshold (e.g., a threshold received from the NW).

The WTRU may be configured to trigger polling based on a request (e.g., from the network and/or application layer). The WTRU may be configured to trigger polling, for example, if the WTRU receives a request to trigger polling for that PDU set or if the WTRU receives a request to trigger polling for that type of PDU set.

The WTRU may be configured to trigger polling based on a PDU reception rate associated with the PDU set. The PDU reception rate may indicate a number of PDUs of the PDU set that have been received or a percentage of PDUs of the PDU set that have been received. In examples, the WTRU may be configured to trigger polling, for example, based on the number of PDUs of PDU set received at time T at the WTRU (e.g., Tx RLC). For example, the WTRU may be configured to trigger polling if the number of PDUs of the PDU set received at time T is greater than a threshold (e.g., a PDU reception threshold). The WTRU may be configured to trigger polling if the number of PDUs of the PDU set received at time T is equal to or less than a threshold (e.g., a PDU reception threshold). The WTRU may be configured to trigger polling, for example, based on the percentage of PDUs of PDU set received at time T. For example, the WTRU may be configured to trigger polling if the percentage of PDUs of the PDU set received at time T is greater than a threshold (e.g., the PDU reception threshold received from the NW). The WTRU may be configured to trigger polling if the percentage of PDUs of the PDU set received at time T is equal to or less than a threshold (e.g., the PDU reception threshold received from the NW). In some examples, the WTRU may be configured to trigger polling, for example, based on the total number of PDUs in the PDU set (e.g., if the total number of PDUs in the PDU set is greater than a threshold, and not triggered if the total number of PDUs in the PDU set is equal to or fewer than the threshold). The WTRU may be configured to trigger polling, for example, based on the size of a buffer at the WTRU (e.g., an RLC buffer). For example, the WTRU may be configured to trigger polling if the size of the buffer is greater than a threshold (e.g., not to trigger polling if the size of the buffer is less than the threshold).

The WTRU (e.g., a transmitting RLC in the WTRU) may send a (e.g., one per data unit granularity) polling indicator (e.g., a polling indicator, a polling bit, a polling flag, or a polling message) to the network (e.g., a receiving RLC at NW) on one or more of the following data unit granularities: per PDU (e.g., one polling indicator per PDU); per PDU set (e.g., one polling indicator per PDU set); part of a PDU set (e.g., the remaining PDUs (e.g., all the remaining PDUs) of the PDU set); part of a data burst (e.g., the remaining PDUs/PDU sets of the data burst); per data burst (e.g., one polling indicator per data burst); per group of PDUs (e.g., one polling indicator per group of PDUs); per group of PDU sets (e.g., one polling indicator per group of PDU sets); per group of data bursts (e.g., one polling indicator per group of data bursts); per bits/bytes/kbits/Mbits/Mbytes, etc. or group thereof; per n bits/bytes/kbits/Mbits/Mbytes (e.g., one polling indicator every n bits/bytes/kbits/Mbits/Mbytes), etc.

The WTRU (e.g., a transmitting RLC in the WTRU) may send the polling indicator (e.g., a polling indicator, a polling bit, a polling flag, or a polling message) in-band (e.g., in the header of the PDU and/or the PDU set) or separately. In examples, a separate PDU indicating polling for a specific data unit or group thereof, possibly with the data unit ID (e.g., with the PDU set ID)) may be sent.

The WTRU may receive one or more status reports after the WTRU sends the polling indicator. In examples, following transmission of the polling indicator, the WTRU (e.g., a Tx RLC) may wait for a time period (e.g., a preconfigured time window) for the reception of one or more status report(s) from the NW.

The WTRU may discard a data unit after the WTRU receives an indication that the data unit has been received (e.g., at the Rx side). In examples, the WTRU may receive, after the polling indicator is sent, the status report indicative of the reception of the PDU set, determine that the PDU set has been received based on the status report; and discard the PDU set based on the determination that the PDU set has been received. In some examples, as soon as the WTRU (e.g., a Tx RLC) receives a status report from the Rx side (e.g., an Rx RLC) confirming a successful delivery of the data unit, the WTRU (e.g., a Tx RLC) may discard the data unit (e.g., a PDU set) or part thereof.

The WTRU may refrain from discarding a data unit until an indication has been received indicating that the data unit has been received. In examples, the WTRU (e.g., a Tx RLC) may not perform discarding until it receives a status report from the Rx side confirming a successful delivery of the data unit. The status report may be (e.g., generated and/or sent) in response to the polling indicator sent by the WTRU, for example.

In examples, the WTRU (e.g., a Tx RLC) may not perform discarding until it receives a status report from the Rx side confirming a successful delivery of the data unit, even if the WTRU (e.g., a Tx RLC) has received an indication from the higher layers (e.g., a Tx PDCP in the WTRU) to discard the data unit or part thereof.

The WTRU may receive a status report per PDU or per PDU set. In examples, the WTRU (e.g., a Tx RLC) may receive one status report indicating a successful or unsuccessful reception for a (e.g., each) PDU in the PDU set. In some examples, the WTRU (e.g., a Tx RLC) may receive one status report indicating a successful or unsuccessful reception for the PDU set. For example, the status report may indicate the status of a (e.g., each) PDU in the PDU set, or the status report may indicate a ‘1’ if the (e.g., all) PDUs of the PDU set are successfully received and a ‘0’ if any PDU(s) of the PDU set has not been received.

One or more of the following features such as holding data units at PDCP, or holding data units at RLC, or receiving-side discarding may be used in association with one or more examples as described herein (e.g., one or more examples on facilitating or ensuring discarding at PDCP, one or more examples on facilitating or ensuring discarding at RLC, or one or more examples on facilitating or ensuring discarding at Rx side PDCP).

Data units may be held at PDCP. A WTRU (e.g., a Tx PDCP entity in the WTRU) may receive a configuration (e.g., conditions/rules/thresholds) from the network that may trigger a holding mechanism, which may include any one or more of the following: thresholds corresponding to parameters of the PDU set (e.g., a threshold may correspond to a parameter of the PDU set); timer/time window configurations T, which, on expiry, may trigger the WTRU to determine whether to do holding (e.g., activate the holding mechanism) or not; or one or more other thresholds.

A WTRU (e.g., a Tx PDCP entity in the WTRU) may receive a configuration (e.g., conditions/rules/thresholds) from the network that may trigger a holding mechanism, which may include thresholds corresponding to parameters of the PDU set. The parameters of the PDU set may include one or more of the following, for example, the size of the PDU set; the number of PDUs of the PDU set; the number and/or percentage of the PDUs of the PDU set received at a certain time; the number and/or percentage of the PDUs of the PDU set received by the PSDB expiry; the number and/or percentage of PDUs of the PDU set received by a time window within the PSDB expiry; the number and/or percentage of the PDUs of the PDU set received before the WTRU (e.g., a Tx PDCP) can forward or transmit the PDUs (and/or the PDU set) to the lower layer (e.g., a Tx RLC), etc.

A WTRU (e.g., a Tx PDCP entity in the WTRU) may receive a configuration (e.g., conditions/rules/thresholds) from the network that may trigger a holding mechanism, which may include timer/time window configurations T. The timer/time window configurations T, on expiry, may trigger the WTRU to determine whether to do holding or not. For example, the timer value T may be standalone. The timer value T may be a function of the PSDB of the PDU set and/or the PDCP discardTimer associated to the PDU set. In examples, at a time t before the expiry of the discardTimer associated to the PDU set, the WTRU may be configured to determine the number and/or the percentage of PDUs of the PDU set that it has received.

A WTRU (e.g., a Tx PDCP entity in the WTRU) may receive a configuration (e.g., conditions/rules/thresholds) from the network that may trigger a holding mechanism, which may include other thresholds. For example, one or more of the other thresholds may correspond to a WTRU buffer size (e.g., as long as a PDCP buffer is filled at X % or less, the WTRU may trigger a holding mechanism; otherwise, the WTRU may not trigger the holding mechanism).

In examples, the WTRU (e.g., a Tx PDCP) may be configured to identify the type of PDU set, e.g., whether the type of PDU set tolerates the loss/delay of any PDU in the PDU set or not.

In examples, the WTRU (e.g., a Tx PDCP) may be configured to detect the presence of an indicator in the PDU set (e.g., a PSIHI indicator) which may provide information as to, for example, how the PDU set is to be treated in the lower layers.

The WTRU (e.g., a Tx PDCP) may be configured to determine the size of the PDU set (e.g., based on sequence numbers) and/or a start and/or end indicator of PDU set. The WTRU (e.g., a Tx PDCP) may receive information on the size of the PDU set, for example, from the higher layer (e.g., the application layer).

The WTRU (e.g., a Tx PDCP) may be configured to determine the number and/or the percentage of PDUs of the PDU set received at a time T (e.g., a time T configured by the network). For example, the WTRU may be able to read the sequence number of PDUs/PDU set. As an example, sequence numbers for PDUs 1, 2, 3 of PDU set 1 may be denoted as (1,1), (1,2), (1,3). Based on the information on the total number of PDUs in the PDU set and the number of PDUs received at time T (e.g., via the sequence numbers), the WTRU may determine the percentage of PDUs of the PDU set received at time T. The WTRU may determine the number or the percentage of PDUs of the PDU set via indications from the higher layers (e.g., application layer(s)).

The WTRU (e.g., a Tx PDCP) may be configured to ‘hold’ the PDUs of the PDU set (and not transmit them to the lower layers, e.g., a Tx RLC) based on one or more of the following conditions. The WTRU may be configured to ‘hold’ the PDUs of the PDU set based on, for example, the number of PDUs of the PDU set received at time T (e.g., if the number of PDUs of PDU set received at time T is greater than a threshold received from the NW). The WTRU may be configured to ‘hold’ the PDUs of the PDU set based on, for example, the percentage of the PDUs of the PDU set received at time T (e.g., if the percentage of PDUs of the PDU set received at time T is greater than a threshold received from the NW). The WTRU may be configured to ‘hold’ the PDUs of the PDU set based on, for example, the total number of PDUs in the PDU set. The WTRU may be configured to ‘hold’ the PDUs of the PDU set based on, for example, the size of a buffer at the WTRU (e.g., a PDCP buffer). For example, the WTRU may be configured to ‘hold’ the PDUs of the PDU set if the size of the buffer is greater than a threshold. The WTRU may be configured to ‘hold’ the PDUs of the PDU set, for example, if the buffer status at the WTRU (e.g., a Tx PDCP buffer) is filled. The WTRU may be configured to ‘hold’ the PDUs of the PDU set, for example, if the buffer status at the WTRU (e.g., a Tx PDCP buffer) is filled at a certain percentage. The WTRU may be configured to ‘hold’ the PDUs of the PDU set, for example, if PDU set importance is greater than a threshold received from the NW. The WTRU may be configured to ‘hold’ the PDUs of the PDU set, for example, if the PDU set is marked with an importance flag/indicator. The WTRU may be configured to ‘hold’ the PDUs of the PDU set, for example, if the PDU set is a PSIHI PDU set (e.g., marked with a PSIHI indicator). The WTRU may be configured to ‘hold’ the PDUs of the PDU set, for example, if the WTRU (e.g., a Tx PDCP) has not received a status report indicating a successful delivery of the PDU set. The WTRU may be configured to ‘hold’ the PDUs of the PDU set, for example, if the WTRU (e.g., a Tx PDCP) has received a status report indicating an unsuccessful delivery of the PDU set or part thereof. The WTRU may be configured to ‘hold’ the PDUs of the PDU set, for example, if the size of the PDU set is greater than a threshold. The WTRU may be configured to ‘hold’ the PDUs of the PDU set, for example, if the size of the PDU set is less than a threshold. The WTRU may be configured to ‘hold’ the PDUs of the PDU set, for example, if PSDB of the PDU set is less than a threshold received from the NW. For example, if the PDCP has a PSIHI PDU set that may warrant an activation of the holding mechanism, the PDCP may not activate the holding mechanism if the PSDB of the PDU set is less than a threshold (e.g., the PDCP may not want to risk the holding mechanism resulting in the PSDB not being met). The WTRU may be configured to ‘hold’ the PDUs of the PDU set, for example, if PSDB of the PDU set is greater than a threshold received from the NW. For example, if the PDCP has a PSIHI PDU set, the PDCP may activate the holding mechanism if the PSDB of the PDU set is greater than a threshold (e.g., only activate the holding mechanism if the PSDB of the PDU set is greater than a threshold). The WTRU may be configured to ‘hold’ the PDUs of the PDU set, for example, if the WTRU receives a request to trigger holding for that PDU set or that type of PDU set (e.g., from the network and/or application layer).

The WTRU (e.g., a Tx PDCP) may be configured to ‘hold’ the PDUs of the PDU set until one or more of the following is/are fulfilled. The WTRU may be configured to ‘hold’ the PDUs of the PDU set for some time (e.g., for a fixed time window configured by the NW; for a time window as a function of the PSDB; for a time window as a function of the discardTimer of the PDU set). The WTRU may be configured to ‘hold’ the PDUs of the PDU set until the (e.g., all) PDUs of the PDU set are received at the WTRU (e.g., a Tx PDCP). The WTRU may be configured to ‘hold’ the PDUs of the PDU set until a certain number of PDUs of the PDU set are received at the WTRU (e.g., a Tx PDCP). The WTRU may be configured to ‘hold’ the PDUs of the PDU set until a certain percentage of PDUs of the PDU set are received at the WTRU (e.g., a Tx PDCP). The WTRU may be configured to ‘hold’ the PDUs of the PDU set until the buffer at the WTRU (e.g., a PDCP buffer) is filled (e.g., completely filled). The WTRU may be configured to ‘hold’ the PDUs of the PDU set until the buffer at the WTRU (e.g., a PDCP buffer) is filled to a certain amount/percentage. The WTRU may be configured to ‘hold’ the PDUs of the PDU set until the WTRU (e.g., a Tx PDCP) receives new data, etc.

The WTRU may send information on the holding mechanism to the network. This may be, for example, in the form of a control PDU that the WTRU (e.g., Tx PDCP) generates. The control PDU may include any one or more of the following information on the holding mechanism: the number of PDUs of a PDU set that are being held; a time duration for which the PDUs of the PDU set have been held; the total amount of time for which the WTRU is to hold/expects to hold the PDUs of the PDU set; the number and/or percentage of the remaining PDUs in the PDU set; the number and/or percentage of the remaining PDUs of the PDU set that the WTRU is to receive before the WTRU can release the holding mechanism; the size of the PDU set; the PDU set ID/sequence number(SN) of the PDU set being held; PDU ID(s)/SN(s) of PDUs being held.

Data units may be held at RLC. A WTRU (e.g., a Tx RLC entity in WTRU) may receive a configuration (e.g., conditions/rules/thresholds) from the network that may trigger a holding mechanism, which may include any one or more of the following: thresholds corresponding to parameters of the PDU set (e.g., a threshold may correspond to a parameter of the PDU set); timer/time window configurations T, which, on expiry, may trigger the WTRU to determine whether to do holding (e.g., activate the holding mechanism) or not; or one or more other thresholds.

A WTRU (e.g., a Tx RLC entity in WTRU) may receive a configuration (e.g., conditions/rules/thresholds) from the network that may trigger a holding mechanism, which may include thresholds corresponding to parameters of a PDU set, for example: a threshold corresponding to the size of a PDU set; a threshold corresponding to the number of PDUs of a PDU set; a threshold corresponding to the number and/or percentage of PDUs of a PDU set received at a certain time; a threshold corresponding to the number and/or percentage of PDUs of a PDU set received by the PSDB expiry; a threshold corresponding to the number and/or percentage of PDUs of a PDU set received by a time window within the PSDB expiry; a threshold corresponding to the number and/or percentage of PDUs of a PDU set received before the WTRU (e.g., a Tx RLC) can forward or transmit the PDUs and/or the PDU set to (e.g., the lower layer such as MAC).

A WTRU (e.g., a Tx RLC entity in WTRU) may receive a configuration (e.g., conditions/rules/thresholds) from the network that may trigger a holding mechanism, which may include other thresholds, for example, corresponding to a size of grant that the WTRU needs to have received (e.g., at MAC) before the WTRU can forward data (e.g., from RLC to MAC) (e.g., this threshold may correspond to the size of one grant or to the size of the sum of multiple grants (e.g., from CG, DG or combination of CG and DG). These other thresholds may include a threshold that corresponds to a WTRU buffer size (e.g., if an RLC buffer is filled at less than 60%, the WTRU may consider triggering the holding mechanism; otherwise no), etc.

A WTRU (e.g., a Tx RLC entity in WTRU) may receive a configuration (e.g., conditions/rules/thresholds) from the network that may trigger a holding mechanism, which may include timer/time window configurations T. The timer/time window configurations T, on expiry, may trigger the WTRU to determine whether to do holding or not. For example, the timer value T may be standalone. The timer value T may be a function of the PSDB of the PDU set. In examples, at a time t before the expiry of the PSDB associated to the PDU set, the WTRU may be configured to determine the number and/or percentage of PDUs of the PDU set it has received.

In examples, the WTRU (e.g., RLC) may be configured to identify the type of PDU set (e.g., whether the type of PDU set type tolerates the loss/delay of any PDU in the PDU set or not).

In some examples, the WTRU (e.g., RLC) may be configured to detect the presence of an indicator in the PDU set (e.g., a PSIHI indicator), which may provide information as to, for example, how the PDU set is to be treated (e.g., in the lower layers).

The WTRU (e.g., RLC) may be configured to determine the size of the PDU set (e.g., based on sequence numbers) and/or determine a start and/or end indicator of the PDU set. The WTRU (e.g., RLC) may receive information on the size of the PDU set, for example, from the higher layer(s) (e.g., the application layer).

The WTRU (e.g., RLC) may be configured to determine the number and/or percentage of PDUs of the PDU set received at a time T (e.g., a time T configured by the network). For example, the WTRU may be able to read the sequence number of PDUs/PDU set. As an example, sequence numbers for PDUs 1, 2, 3 of PDU set 1 may be denoted as (1,1), (1,2), (1,3). Based on information on the total number of PDUs in the PDU set and the number of PDUs receives at time T (e.g., via the sequence numbers), the WTRU may determine the percentage of PDUs of the PDU set received at time T. The WTRU may determine the number or the percentage of PDUs of the PDU set via indications (e.g., from the higher layers (e.g., application layer(s))).

The WTRU (e.g., RLC) may be configured to ‘hold’ the PDUs of the PDU set (and not transmit them to the lower layers, e.g., MAC) based on one or more of the following conditions. The WTRU may be configured to ‘hold’ the PDUs of the PDU set, for example, based on indication(s). The indication(s) may be from the lower layers (e.g., MAC). The indications may include one or more of the following. The indications may indicate the size of one or more grants available (e.g., grants available at MAC). For example, if the size of the grants available (e.g., at MAC) is not sufficient to accommodate the entire PDU set, or at least a certain amount/percentage of the PDU set, the WTRU may be configured to hold (e.g., at the RLC) the PDUs of the PDU set that may have already been received (e.g., at the RLC). In some examples, for a PDU set associated with a PSIHI indicator, the WTRU (e.g., RLC) may wait until it has received an indication that the WTRU (e.g., MAC) has one or more grant(s) large enough to accommodate the entire PDU set before sending the PDUs of that PDU set (e.g., to the lower layers such as MAC), for example, since the remaining PDUs of the PDU set may be unusable (e.g., useless) if even one PDU of the PDU set is delayed or lost. The indications may include the number of grants available (e.g., available at MAC). The indications may include the size of sum of the grants available (e.g., the sum of all grants available at MAC). The grants may correspond to one or more of CG grants, DG grants or a combination thereof. The indications may include the number of grants expected to be available (e.g., the number of grants expected to be available at MAC within a preconfigured time window). The indications may include the size of grants expected to be available (e.g., the size of grants expected to be available at MAC within a preconfigured time window).

The WTRU may be configured to ‘hold’ the PDUs of the PDU set based on the number of PDUs of the PDU set received at time T, for example, if the number of PDUs of the PDU set received at time T is greater than a threshold (e.g., a threshold received from the NW). The WTRU may be configured to ‘hold’ the PDUs of the PDU set based on the percentage of PDUs of the PDU set received at time T, for example, if the percentage of PDUs of the PDU set received at time T is greater than a threshold (e.g., a threshold received from the NW). The WTRU may be configured to ‘hold’ the PDUs of the PDU set, for example, based on the total number of PDUs in the PDU set. The WTRU may be configured to ‘hold’ the PDUs of the PDU set based on the size of a buffer at WTRU (e.g., an RLC buffer), for example, if the size of the buffer is greater than a threshold. The WTRU may be configured to ‘hold’ the PDUs of the PDU set, for example, if the buffer status at the WTRU (e.g., a Tx RLC buffer) is filled. The WTRU may be configured to ‘hold’ the PDUs of the PDU set, for example, if the buffer status at the WTRU (e.g., a Tx RLC buffer) is filled at a certain percentage. The WTRU may be configured to ‘hold’ the PDUs of the PDU set, for example, if the importance of the PDU set is greater than a threshold (e.g., a threshold received from the NW). The WTRU may be configured to ‘hold’ the PDUs of the PDU set, for example, if the PDU set is marked with an importance flag/indicator. The WTRU may be configured to ‘hold’ the PDUs of the PDU set, for example, if the PDU set is a PSIHI PDU set (e.g., marked with a PSIHI indicator). The WTRU may be configured to ‘hold’ the PDUs of the PDU set, for example, if the WTRU (e.g., RLC) has not received a status report indicating the successful delivery of the PDU set. The WTRU may be configured to ‘hold’ the PDUs of the PDU set, for example, if the WTRU (e.g., RLC) has received a status report indicating the unsuccessful delivery of the PDU set or part thereof. The WTRU may be configured to ‘hold’ the PDUs of the PDU set, for example, if the size of the PDU set is greater than a threshold. The WTRU may be configured to ‘hold’ the PDUs of the PDU set, for example, if the size of the PDU set is less than a threshold.

The WTRU may be configured to ‘hold’ the PDUs of the PDU set, for example, if PSDB of the PDU set is less than a threshold (e.g., a threshold received from the NW). In examples, if the RLC has a PSIHI PDU set and it has not received an indication of sufficient grant(s) available (e.g., an indication of sufficient grant(s) available at the MAC) to accommodate the entire PDU set, the RLC may not activate the holding mechanism if the PSDB of the PDU set is less than a threshold (e.g., the RLC may not want to risk the holding mechanism resulting in the PSDB not being met). The WTRU may be configured to ‘hold’ the PDUs of the PDU set, for example, if PSDB of the PDU set is greater than a threshold (e.g., a threshold received from the NW). In examples, if the RLC has a PSIHI PDU set and it has not received an indication of sufficient grant(s) available (e.g., an indication of sufficient grant(s) available at the MAC) to accommodate the entire PDU set, the RLC may activate (e.g., only activate) the holding mechanism if the PSDB of the PDU set is greater than a threshold.

The WTRU may be configured to ‘hold’ the PDUs of the PDU set, for example, if the WTRU receives a request to trigger holding for that PDU set or that type of PDU set (e.g., from the network and/or application layer).

The WTRU (e.g., a Tx RLC) may be configured to ‘hold’ the PDUs of the PDU set until one or more of the following is/are fulfilled. The WTRU may be configured to ‘hold’ the PDUs of the PDU set, for example, until the WTRU (e.g., RLC) has received an indication (e.g., from the lower layers such as MAC) that sufficient grant(s) (e.g., from one or more grants) is available to fit the entire PDU set. The WTRU may be configured to ‘hold’ the PDUs of the PDU set, for example, until the WTRU (e.g., RLC) has received an indication (e.g., from the lower layers such as MAC) that sufficient grant(s) (e.g., from one or more grants) is available to fit at least a certain amount/percentage of the PDU set (e.g., at least 80% of the PDU set). The WTRU may be configured to ‘hold’ the PDUs of the PDU set for some time (e.g., for a fixed time window configured by the NW, for a time window as a function of the PSDB, or for a time window as a function of the discardTimer of the PDU set). The WTRU may be configured to ‘hold’ the PDUs of the PDU set, for example, until the (e.g., all) PDUs of the PDU set are received at the WTRU (e.g., Tx RLC). The WTRU may be configured to ‘hold’ the PDUs of the PDU set, for example, until a certain number of PDUs of the PDU set are received at the WTRU (e.g., a Tx RLC). The WTRU may be configured to ‘hold’ the PDUs of the PDU set, for example, until a certain percentage of PDUs of the PDU set are received at the WTRU (e.g., a Tx RLC). The WTRU may be configured to ‘hold’ the PDUs of the PDU set, for example, until the buffer at the WTRU (e.g., an RLC buffer) is filled (e.g., completely filled). The WTRU may be configured to ‘hold’ the PDUs of the PDU set, for example, until the buffer at the WTRU (e.g., an RLC buffer) is filled to a certain amount/percentage. The WTRU may be configured to ‘hold’ the PDUs of the PDU set, for example, until the WTRU (e.g., a Tx RLC) receives new data.

The WTRU (e.g., a Tx RLC) may send information on the holding mechanism to the network (e.g., a Rx RLC). This may be, for example, in the form of a status PDU that the WTRU (e.g., a Tx RLC) generates. The status PDU may include one or more of the following information on the holding mechanism: the number of PDUs of the PDU set that are being held; the amount of (additional) grant needed to release the holding mechanism; the time duration for which the PDUs of the PDU set have been held; the total amount of time for which the WTRU is to hold/expects to hold the PDUs of the PDU set; the number and/or percentage of the remaining PDUs in the PDU set; the number and/or percentage of the remaining PDUs of the PDU set that WTRU is to receive before it can release the holding mechanism; the size of the PDU set; the PDU set ID/sequence number(SN) of the PDU set being held; the PDU ID(s)/SN(s) of PDUs being held.

The WTRU (e.g., Tx RLC) may send an indication on the holding mechanism (e.g., to the lower layers such as MAC). The WTRU (e.g., MAC) may then send an indication (e.g., in a MAC CE, SR, BSR) to the network to inform the network about the holding mechanism including one or more of: the number of PDUs of the PDU set that are being held; the amount of (additional) grant needed to release the holding mechanism; the time duration for which the PDUs of the PDU set have been held; the total amount of time for which the WTRU is to hold/expects to hold the PDUs of the PDU set; the number and/or percentage of the remaining PDUs in the PDU set; the number and/or percentage of remaining PDUs of the PDU set the WTRU is to receive before it can release the holding mechanism; the size of the PDU set; the PDU set ID/sequence number(SN) of PDU set being held; the PDU ID(s)/SN(s) of PDUs being held.

In examples, the WTRU (e.g., a Tx RLC) may have a buffer (e.g., an RLC buffer) dedicated for the holding mechanism. For example, the PSIHI PDU set(s) (e.g., only the PSIHI PDU set(s)) may be eligible for the buffer (e.g., the RLC buffer) dedicated to the holding mechanism.

In some examples, the WTRU (e.g., a Tx RLC) may use a buffer (e.g., the legacy RLC buffer) for all types of data, in which case, a reception of new data may trigger one or more of the following: an end of the holding mechanism; an end of the holding mechanism if (e.g., only if) the RLC buffer is filled (e.g., completely filled); an end of the holding mechanism if (e.g., only if) the RLC buffer is filled to a certain amount/percentage. In some examples, the WTRU (e.g., a Tx RLC) may use a buffer (e.g., the legacy RLC buffer) for all types of data, in which case, a reception of new data may trigger one or more of the following WTRU actions based on the priority of the new data with regards to the priority of the PSIHI data. For example, if the priority of the new data is greater than the priority of a PSIHI PDU set, the WTRU may transmit the new data (e.g., to lower layers such as MAC whenever a resource/grant becomes available). If the priority of the new data is less than or equal to the priority of the PSIHI PDU set, the WTRU may transmit the PSIHI PDU set (e.g., to the first available grant, irrespective of the grant size).

Receiving side (e.g., PDCP) may perform discarding (e.g., on downlink). In examples, the WTRU (e.g., an Rx PDCP) may be configured to perform discarding. The WTRU (e.g., an Rx PDCP) may receive indication(s) from the network (and/or higher layers (e.g., application layer(s))) about data (e.g., in a QoS flow) that may be treated as PSIHI PDU set(s). For example, the network may not have managed to perform the collective discard in time and it may send an indication to the Rx PDCP. In examples, data that is not considered as PSIHI PDU set(s) by the network may be considered by the WTRU as PSIHI PDU set(s) (e.g., due to the encoding scheme at the WTRU).

The WTRU (e.g., an Rx PDCP) may detect (e.g., based on SN(s) of PDUs in the PDU set) the loss or delay of some PDUs of the PDU set that is treated (e.g., must be treated) as a PSIHI PDU set. The WTRU (e.g., an Rx PDCP) may send an indication to the network about the change in the status of the PDU set (e.g., the change of the status from a regular PDU set to a PSIHI PDU set). If the PSDB of the PDU set is reached, the WTRU (e.g., an Rx PDCP) may discard the remaining PDUs (e.g., any remaining/other PDUs) of the PDU set.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a processor configured to:
receive configuration information, wherein the configuration information indicates a time period;
determine that a status report associated with a protocol data unit (PDU) set has not been received by the WTRU;
determine, based on the time period, that a polling indicator is to be sent; and
send the polling indicator, wherein the polling indicator indicates a request for a transmission of the status report associated with the PDU set.

17. The WTRU of claim 16, wherein the polling indicator is determined to be sent based on an expiry of the time period and a timing characteristic of the PDU set.

18. The WTRU of claim 16, wherein the PDU set is a radio link control (RLC) PDU set, the polling indicator is determined to be sent at a RLC level, and the polling indicator is sent to a network in a RLC packet.

19. The WTRU of claim 16, wherein the time period is a standalone time value or is determined based on a PDU set delay budget (PSDB) associated with the PDU set.

20. The WTRU of claim 16, wherein the processor is further configured to:
determine a PDU set delay budget (PSDB) threshold; and
determine that a PSDB associated with the PDU set is less than the PSDB threshold, wherein the polling indicator is determined to be sent further based on the determination that the PSDB associated with the PDU set is less than the PSDB threshold.

21. The WTRU of claim 16, wherein the status report associated with the PDU set is used to indicate a reception of the PDU set.

22. The WTRU of claim 16, wherein the processor is further configured to:
determine a PDU reception rate associated with the PDU set, wherein the PDU reception rate indicates a number or a percentage of PDUs of the PDU set that have been received; and
determine that the PDU reception rate associated with the PDU set is equal to or less than a PDU reception threshold, wherein the polling indicator is determined to be sent further based on the determination that PDU reception rate associated with the PDU set is equal to or less than the PDU reception threshold.

23. The WTRU of claim 16, wherein the processor is further configured to:
receive, after the polling indicator is sent, the status report indicative of the reception of the PDU set;
determine that the PDU set has been received based on the status report; and
discard the PDU set based on the determination that the PDU set has been received.

24. A method performed by a wireless transmit/receive unit (WTRU), comprising:
receiving configuration information, wherein the configuration information indicates a time period;
determining that a status report associated with a protocol data unit (PDU) set has not been received by the WTRU;
determining, based on the time period, that a polling indicator is to be sent; and
sending the polling indicator, wherein the polling indicator indicates a request for a transmission of the status report associated with the PDU set.

25. The method of claim 24, wherein the polling indicator is determined to be sent based on an expiry of the time period and a timing characteristic of the PDU set.

26. The method of claim 24, wherein the PDU set is a radio link control (RLC) PDU set, the polling indicator is determined to be sent at a RLC level, and the polling indicator is sent to a network in a RLC packet.

27. The method of claim 24, wherein the time period is a standalone time value or is determined based on a PDU set delay budget (PSDB) associated with the PDU set.

28. The method of claim 24, further comprising:
determining a PDU set delay budget (PSDB) threshold; and
determining that a PSDB associated with the PDU set is less than the PSDB threshold, wherein the polling indicator is determined to be sent further based on the determination that the PSDB associated with the PDU set is less than the PSDB threshold.

29. The method of claim 24, wherein the status report associated with the PDU set is used to indicate a reception of the PDU set.

30. The method of claim 24, further comprising:
determining a PDU reception rate associated with the PDU set, wherein the PDU reception rate indicates a number or a percentage of PDUs of the PDU set that have been received; and
determining that the PDU reception rate associated with the PDU set is equal to or less than a PDU reception threshold, wherein the polling indicator is determined to be sent further based on the determination that PDU reception rate associated with the PDU set is equal to or less than the PDU reception threshold.

31. The method of claim 24, further comprising:
receiving, after the polling indicator is sent, the status report indicative of the reception of the PDU set;
determining that the PDU set has been received based on the status report; and
discarding the PDU set based on the determination that the PDU set has been received.
